(19) United States
(12) Patent Application Publication
(10) Pub. No.: US 2012/0220169 A1
(43) Pub. Date: Aug. 30, 2012

(54) ELECTRONIC COMPONENT SOCKET

(75) Inventors: Takeki UOZUMI, Miyagi-ken (JP); Daisuke TAKAI, Miyagi-ken (JP); Shinji MURATA, Miyagi-ken (JP)

(73) Assignee: Alps Electric Co., Ltd., Ota-ku (JP)

(21) Appl. No.: 13/401,946

(22) Filed: Feb. 22, 2012

(30) Foreign Application Priority Data
Feb. 24, 2011 (JP) 2011-037736
Feb. 24, 2011 (JP) 2011-037737

(51) Int. Cl. H01R 24/20

(52) U.S. Cl. 439/660

(57) ABSTRACT

An electronic component socket includes a housing having a housing portion surrounded with a side wall and a bottom wall; multiple terminals to be disposed so as to pass through the bottom wall of the housing; and a metal plate configured to form at least a portion of the bottom wall of the housing, having multiple through-holes containable with the multiple terminals; with the plurality of terminals including a contact portion contactable with an electrode of an electronic component containable with the housing, and a connection portion connectable with a round of a substrate allocatable on the opposite side of the housing of the bottom wall; and with the metal plate being embedded in the housing so that a portion thereof is exposed.

### CLAIM OF PRIORITY

This application contains subject matter related to and claims the benefit of the following Japanese Patent Applications: No. 2011-037737, filed on Feb. 24, 2011 and No. 2011-037736 filed on Feb. 24, 2011. The entire contents of each of these applications are hereby incorporated by reference.

### BACKGROUND OF THE DISCLOSURE

1. Field of the Disclosure

The present disclosure relates to a socket, and specifically relates to an electronic component socket for electrically connecting an electronic component and a circuit substrate.

2. Description of the Related Art

In recent years, integrated circuits such as computer processors employ a great number of signals for processing a lot of information at high speed for a short time, and realize high density by arraying ejection terminals for several hundreds of signals with a very narrow pitch of around 1 mm. The electronic components with advanced high density have a greater outer diameter as compared to a common electronic component, and are apt to have a further greater outer diameter along with increase in the number of signal pins in the future. BGA (Ball grid array) packages and LGA (Land grid array) packages and so forth which house an integrated circuit are well known as the electronic components with advanced high density, for example. These electronic components are commonly mounted on a circuit substrate using an electronic component socket to obtain reliability of connection instead of a type for mounting components on a circuit substrate directly by solder.

For example, in Japanese Unexamined Patent Application Publication (Translation of PCT Application) No. 2007-500923, as illustrated in FIGS. 11 and 12A through 12C, an LGA socket 900 including an electroconductive contact 910 for electrically connecting an LGA package and a circuit substrate has been proposed. The LGA socket 900 illustrated in FIGS. 11 and 12A through 12C are configured of an insulating housing member 904, a substrate 906 having multiple through-holes 990 arrayed in an array shape, and a contact assembly 908 holding the electroconductive contact 910 at an insulating member 912. The contact assembly 908 is pressed into each of the multiple through-holes 990 of the substrate 906, this substrate 906 is snap-engaged with the insulating housing member 904 using the latch members 930 and 942 of the insulating housing member 904, thereby making up the LGA socket 900. In this way, according to the configuration wherein the substrate 906 of the bottom wall is snap-engaged with the insulating housing member 904 of the frame body, and accordingly, time creep to be caused after thermal exposure and thermal recycle during manufacturing or use can be prevented as compared to housing formed with resin alone. Also, according to the configuration wherein the contact assembly 908 is pressed into each of the multiple through-holes 990 arrayed in an array shape of the substrate 906, the electroconductive contact 910 (terminal) can be disposed on the bottom wall in an array shape while maintaining insulation properties with the substrate 906 made of metal by the insulating member 912.

Incidentally, though this electronic component socket is employed to obtain reliability of connection between an electronic component and a circuit substrate, demands for coplanarity of a terminal connecting the electronic component and the circuit substrate have increased along with increase in the number of signals. In the event that this terminal coplanarity is low, defective soldering of the terminal as to the circuit substrate, or poor contact as to the electronic component occurs. In particular, a general-purpose printed circuit board (PCB) is frequently used as the circuit substrate, improvement of coplanarity of a terminal of the electronic component socket has increasingly been demanded for covering the properties of the PCB with low coplanarity.

However, with a configuration such as an existing example, the substrate 906 of the bottom wall is simply snap-engaged with the insulating housing member 904 of the frame body, it is difficult to suppress modification such as warpage of the insulating housing member 904 due to thermal exposure and thermal recycle during manufacturing or use. In particular, there is no configuration for easing warpage of the side wall of the insulating housing member 904, and accordingly, in the event that the side wall of the insulating housing member 904 is warped, the substrate 906 positioned in the bottom wall is also warped, and accordingly, the coplanarity of the electroconductive contact 910 (terminal) disposed on the substrate 906 may be deteriorated. Also, the housing is apt to be increased along with increase in the number of signals in the future, and accordingly, deformation of the housing increases, and the coplanarity of the terminal may increasingly be deteriorated. Also, according to high density along with increase in the number of signals of an electronic component, a problem occurs such that electric operation between adjacent wirings is strengthened, and electric reflection noise or radiated noise is increased, and improvement in shielding performance as to signal terminals has been demanded. However, with a configuration such as an existing example, shielding performance has particularly not been taken into consideration.

These and other drawbacks exist.

### SUMMARY OF THE DISCLOSURE

Embodiments of the present disclosure provide an electronic component socket whereby shielding performance as to signal terminals can be improved along with deformation of warpage of a housing or the like due to heat at the time of manufacturing or use being suppressed, and improvement in coplanarity of a terminal being realized.

To this end, an electronic component socket according to an aspect of the present disclosure includes: a housing having a housing portion surrounded with a side wall and a bottom wall; multiple terminals to be disposed so as to pass through the bottom wall of the housing; and a metal plate configured to form at least a portion of the bottom wall of the housing, having multiple through-holes containable with the multiple terminals; characterized in that the plurality of terminals includes a contact portion contactable with an electrode of an electronic component containable with the housing, and a connection portion connectable with a round of a substrate allocatable on the opposite side of the housing of the bottom wall, the metal plate is embedded in the housing so that a portion thereof is exposed.

According to this configuration, with the electronic component socket, a portion of the metal plate is embedded in the housing, and accordingly, this metal plate reinforces the synthetic resin portion, and consequently, the bending strength of the entire housing can be improved. Therefore, according to this metal plate, warpage of the entire housing caused due to heat at the time of manufacturing or use of the electronic component socket can be suppressed. Thus, the coplanarity of the contact portions and connection portions of the multiple terminals stored in the through-holes of the metal plate can further be improved.

A portion of the metal plate may be bent and embedded up to the side wall of the housing.

According to this configuration, the metal plate is embedded even in the side wall of the housing, and accordingly, warpage of the side wall of the housing can be suppressed by this metal plate. Thus, the coplanarity of the contact portions and connection portions of the multiple terminals can further be improved.

An opening may be provided to the central portion of the metal plate embedded in the bottom wall, and a protrusion extended toward the housing portion side is provided to the circumference of this opening.

According to this configuration, a protrusion extended toward the housing portion side is provided to the circumference of an opening provided to the central portion of the metal plate embedded in the bottom wall, and accordingly, the bending strength of the planar-shaped metal plate can be improved. Thus, warpage of the entire housing can be suppressed by the metal plate with the improved bending strength, and the coplanarity of the contact portions and connection portions of the multiple terminals can further be improved.

A slit may be formed in a portion where the metal plate of the side wall is not disposed.

According to this configuration, a configuration is employed wherein a slit is formed in the side wall, and the side wall is not restrained, and accordingly, as compared to a case where the side wall is formed in a manner connected across the entire length, warpage of the side wall due to thermal expansion or thermal contraction at the time of manufacturing or use can be suppressed. Thus, the coplanarity of the contact portions and connection portions of the multiple terminals can further be improved.

The slit may be formed on both sides of the side wall in one of a pair of the side walls facing.

According to this configuration, the slit is formed on both sides of the side wall in one of a pair of the side walls facing, and accordingly, warpage of the side wall can be suppressed in a well-balanced manner. Thus, the coplanarity of the contact portions and connection portions of the multiple terminals can further be improved.

At least a part of the terminals may be covered with an insulating resin, and the insulating resin portion is disposed so as to be fitted into the through-holes of the metal plate.

According to this configuration, the insulating resin portion covering a part of the terminals is disposed so as to be fitted into the through-holes of the metal plate, and accordingly, the multiple terminals can be held at the metal plate with strong bending strength in a sure manner. Thus, the coplanarity of the contact portions and connection portions of the multiple terminals can further be improved.

A terminal unit may be formed by covering and linking some of the plurality of terminals with an insulating resin so that each of the terminals is not electrically conducted.

According to this configuration, a terminal unit is formed by covering and liking the multiple terminals with an insulating resin, and accordingly, assembly properties can be improved as compared to a case where the terminals are disposed in the through-holes of the metal plate one at a time.

The through-holes of the metal plate may be provided so that the two or more terminals are housed, the terminal unit is formed with multiple terminals so as to be housed in a plurality of the through-holes, a groove portion is formed in the insulating resin portion for each of the two or more terminals, and a partitioning portion for partitioning the through-holes is provided to the groove portion at the time of implementation of the terminal unit as to the through-holes.

According to this configuration, there is a partitioning portion between a through-hole and another through-hole, and accordingly, as compared to a case where a terminal unit is mounted by forming a train of through-holes, the strength of the metal plate is improved, and also flexure of the terminal unit is suppressed. Thus, the coplanarity of the contact portions and connection portions of the multiple terminals can further be improved.

A protruding or recessed portion for positioning the terminal unit may be formed in the inner wall of the through-holes of the metal plate.

According to this configuration, a protruding or recessed portion for positioning the terminal unit is formed in the inner walls of the through-holes of the metal plate, and accordingly, positioning precision of the terminal unit can be improved.

The metal plate may be made up of a plurality of metal materials, and at least one of the multiple metal materials is bent and embedded within the side wall.

According to this configuration, the metal plate is made up of multiple metal materials, and at least one of the multiple metal materials is bent and embedded within the side wall, and accordingly, the strength of the side wall can be improved without thickening the thickness of the side wall. Thus, warpage of the side wall of the housing can be suppressed with a bent portion of the metal plate, and the coplanarity of the contact portions and connection portions of the multiple terminals can further be improved.

At least one of the multiple metal materials may be embedded extended toward the upward side within the side wall, and another one is embedded extended toward the downward side within the side wall.

According to this configuration, the metal plate is made up of multiple metal materials, and separate metal materials are extended and embedded by being vertically divided within the side wall, and accordingly, the strength of the side wall can further be improved without thickening the thickness of the side wall. Thus, warpage of the side wall of the housing can be suppressed by the metal plate, and the coplanarity of the contact portions and connection portions of the multiple terminals can further be improved.

The metal plate may be made up of multiple metal materials, and the protrusion is formed as to at least one of the multiple metal materials.

According to this configuration, the metal plate is made up of multiple metal materials, and the protrusion is formed as to at least one of the multiple metal materials, and accordingly, multiple sheets of metal materials are overlaid, and accordingly, the bending strength of the planar-shaped metal plate can further be improved, and further at the time of forming the protrusion on the multiple sheets of metal materials, the bending strength of the planar-shaped metal plate can even further be improved. Thus, warpage of the entire housing can be suppressed by the metal plate with improved bending strength, and the coplanarity of the contact portions and connection portions of the multiple terminals can further be improved.

The metal plate may be made up of multiple metal materials, a metal material to be embedded within the side wall is disposed most downward, a metal material where the protrusion is formed is disposed most upward, and at least another metal material is disposed therebetween.

According to this configuration, the metal plate is made up of multiple metal materials, a metal material to be embedded within the side wall is disposed most downward, a metal material where the protrusion is formed is disposed most upward, and at least another metal material is disposed therebetween, and accordingly, the metal plate is configured of at least three layers or more of metal materials, and the functions of the metal materials are divided, and accordingly, the electronic component socket can be formed small in size.

A hole portion may be provided to the central portion of a portion embedded in the bottom wall of the most downward metal material, and a downward protrusion extended toward the substrate side is formed in the circumference of the hole portion.

According to this configuration, a downward protrusion extended toward the downward side is formed in the circumference of a hole portion provided to the central portion of the metal plate of the bottom wall, and accordingly, the bending strength of the planar-shaped metal plate can be improved. Thus, warpage of the side wall of the housing can be suppressed by the metal plate with improved bending strength, and the coplanarity of the contact portions and connection portions of the multiple terminals can further be improved.

A portion where the metal plate is embedded may be embedded within the housing by insert molding.

According to this configuration, the metal plate is embedded in the housing by insert molding, and accordingly, the housing with a portion of the bottom wall as metal can readily be formed. Thus, manufacturing can readily be performed, and manufacturing cost can be suppressed.

At least one of the multiple terminals may be taken as a signal terminal, with the plurality of terminals adjacent to this signal terminal taken as ground terminals, and the ground terminals electrically conducting with the metal plate via electroconducting means.

According to this configuration, with the electronic component socket, the circumference of the signal terminal is surrounded with ground terminals, and also the ground terminals electrically conduct with the metal plate via the electroconductive means, and accordingly, the metal plate can be grounded. Thus, electric reflection noise or radiated noise can be shielded with the ground terminals and metal plate, and shielding performance as to the signal terminals can be improved.

The electroconducting means may electrically conduct by protruding portions provided extended from the inner walls of the through-holes of the metal plate coming into contact with the ground terminals.

According to this configuration, electrical conduction is realized by protruding portions provided extended from the inner walls of the through-holes of the metal plate coming into contact with the ground terminals, and accordingly, the ground terminals and metal plate can electrically conduct by the protruding portions in a sure manner just by disposing the ground terminals in the through-holes of the metal plate. Thus, the metal plate can be grounded in a sure manner, and electric reflection noise or radiated noise can be shielded with the ground terminals and metal plate, and accordingly, shielding performance as to the signal terminals can be improved.

The metal plate may be made up of multiple metal materials, with the protruding portion provided to at least one of the metal materials.

According to this configuration, the metal plate is made up of multiple metal materials, electric conduction is realized by the protruding portion of at least one metal material coming into contact with the ground terminals, and accordingly, the ground terminals and the metal plate can electrically conduct by the protruding portion in a sure manner just by disposing the ground terminals in the through-holes of the metal plate. Thus, the metal plate can be grounded in a sure manner, and electric reflection noise or radiated noise can be shielded with the ground terminals and metal plate, and accordingly, shielding performance as to the signal terminals can be improved.

the electroconducting means may electrically conduct by ground terminal protruding portions provided extended from the ground terminals coming into contact with the inner walls of the through-holes of the metal plate.

According to this configuration, electric conduction is realized by the ground terminal protruding portion extended and provided from the ground terminals coming into contact with the metal plate, and accordingly, the ground terminals and the metal plate can electrically conduct by the ground terminal protruding portion in a sure manner just by disposing the ground terminals in the through-holes of the metal plate. Thus, the metal plate can be grounded in a sure manner, and electric reflection noise or radiated noise can be shielded with the ground terminals and metal plate, and accordingly, shielding performance as to the signal terminals can be improved.

A signal terminal protruding portion extended from the signal terminal may be provided to the signal terminal, and an avoidance portion configured so as not to electrically conduct with the signal terminal protruding portion is provided to the metal plate.

According to this configuration, the avoidance portion for preventing the signal terminal protruding portion provided to a signal terminal from electrically conducting with the metal plate is provided, and accordingly, even if there is a signal terminal protruding portion in a signal terminal, the signal terminal can be prevented from electrically conducting with the metal plate. Thus, the signal terminals and ground terminals can be manufactured and used in common, so manufacturing cost can be suppressed.

With the plurality of terminals, the signal terminals and the ground terminals may be alternately disposed.

According to this configuration, the signal terminals and ground terminals are alternately disposed, and accordingly, regarding all of the signal terminals, the ground terminals can be disposed so as to surround the signal terminals. Thus, electric reflection noise or radiated noise can be shielded with the ground terminals, and shielding performance as to all of the signal terminals can be improved.

At least a part of the terminals may be covered with an insulating resin, with the insulating resin portion being disposed by being fitted into the through-holes of the metal plate.

According to this configuration, the insulating resin portion covering the terminals is disposed by being fitted into the through-holes of the metal plate, and accordingly, insulation between the signal terminals and the metal plate can be performed in a sure manner. Thus, shielding performance as to the signal terminals can further be improved.

A terminal unit may be formed by covering and linking some of the multiple terminals with an insulating resin so that each of the terminals are not electrically connected.

According to this configuration, a terminal unit is formed by covering and liking the multiple terminals with an insulating resin, and accordingly assembly properties can be improved as compared to a case where the terminals are disposed in the through-holes of the metal plate one at a time.

The through-holes may be made up of a plurality of divided through-holes divided for at least every two terminals of a plurality of terminals provided to the terminal unit, with one of at least the two terminals provided to the divided through-holes being the ground terminal.

According to this configuration, one of at least two terminals disposed in a through-hole is taken as the ground terminal, and accordingly, at least the two terminals form a pair including the ground terminal, and accordingly, shielding performance as to the terminal making up the pair with the ground terminal can be improved.

Accordingly, the present disclosure can provide an electronic component socket whereby deformation such as warpage of the housing due to heat at the time of manufacturing or use, and so forth can be suppressed, and improvement in the coplanarity of a terminal can be realized, and also, shielding performance as to the signal terminals can be improved.

### BRIEF DESCRIPTION OF THE DRAWINGS

FIG. 1 is an exploded perspective view for illustrating an electronic component socket according to an exemplary embodiment of the present disclosure;

FIGS. 2A and 2B are diagrams for illustrating the electronic component socket according to an exemplary embodiment of the present disclosure, wherein FIG. 2A is a perspective view, and FIG. 2B is a top view as viewed from the Z1 side illustrated in FIG. 2A;

FIGS. 3A and 3B are diagrams for illustrating a housing of the electronic component socket according to an exemplary embodiment of the present disclosure, wherein FIG. 3A is a perspective view, and FIG. 3B is a bottom view as viewed from the Z2 side illustrated in FIG. 3A;

FIG. 4 is a diagram for illustrating the housing of the electronic component socket according to an exemplary embodiment of the present disclosure, and is a perspective view of a metal plate;

FIGS. 5A and 5B are diagrams for illustrating the electronic component socket according to an exemplary embodiment of the present disclosure, wherein FIG. 5A is a side view as viewed from the Y2 side illustrated in FIG. 2A, and FIG. 5B is a cross-sectional view taken along the VB-VB line illustrated in FIG. 2B;

FIGS. 6A through 6C are diagrams for illustrating the electronic component socket according to an exemplary embodiment of the present disclosure, wherein FIG. 6A is a perspective view of a terminal, FIG. 6B is a perspective view of a terminal unit, and FIG. 6C is a front view of the terminal unit as viewed from the Y2 side illustrated in FIG. 1;

FIGS. 7A and 7B are diagrams for illustrating the electronic component socket according to an exemplary embodiment of the present disclosure, wherein FIG. 7A is an enlarged bottom view as viewed from the Z2 side of the VIIA portion illustrated in FIG. 2A, and FIG. 7B is a cross-sectional view taken along the VIIB-VIIB line illustrated in FIG. 7A;

FIGS. 8A and 8B are diagrams for illustrating the electronic component socket according to an exemplary embodiment of the present disclosure, wherein FIG. 8A is an enlarged perspective view of the metal plate of the VIIIA portion illustrated in FIG. 3A, and FIG. 8B is an enlarged top view of the metal plate of the VIIIB portion illustrated in FIG. 2B;

FIG. 9 is a diagram for describing a modification 1 of the electronic component socket according to an exemplary embodiment of the present disclosure, and is a perspective view of a metal plate;

FIG. 10 is a diagram for illustrating a modification of the electronic component socket according to an exemplary embodiment of the present disclosure, and is an exploded perspective view of a metal plate;

FIG. 11 is a plan view for illustrating an LGA socket according to an exemplary embodiment of the disclosure;

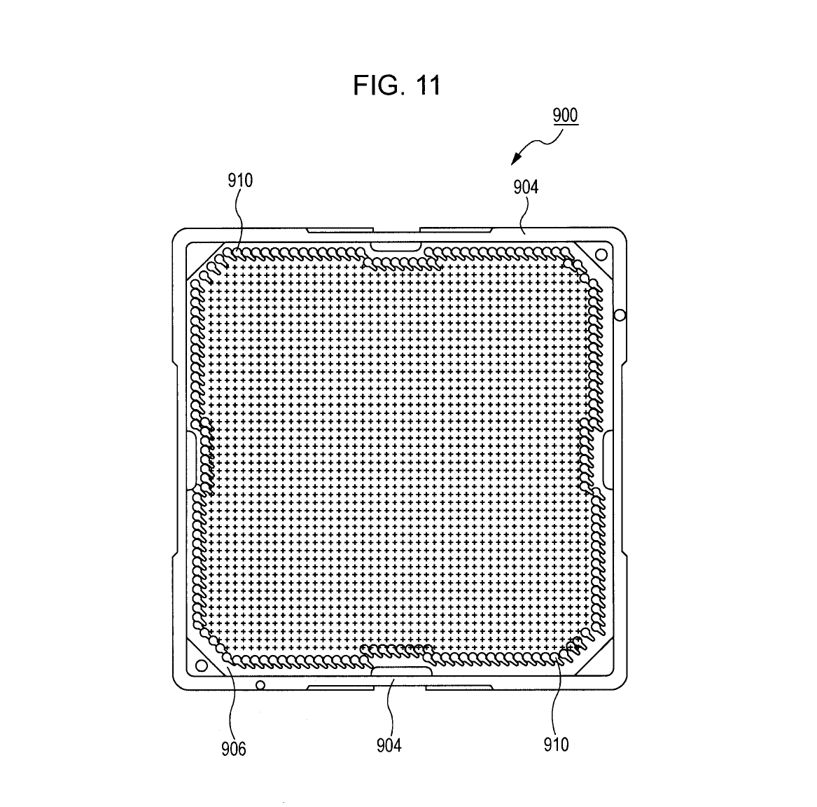

FIGS. 12A through 12C are diagrams for illustrating the LGA socket according to an exemplary embodiment, wherein FIG. 12A is a plan view of an insulating housing member, FIG. 12B is a plan view of a substrate, and FIG. 12C is a front view of a contact assembly;

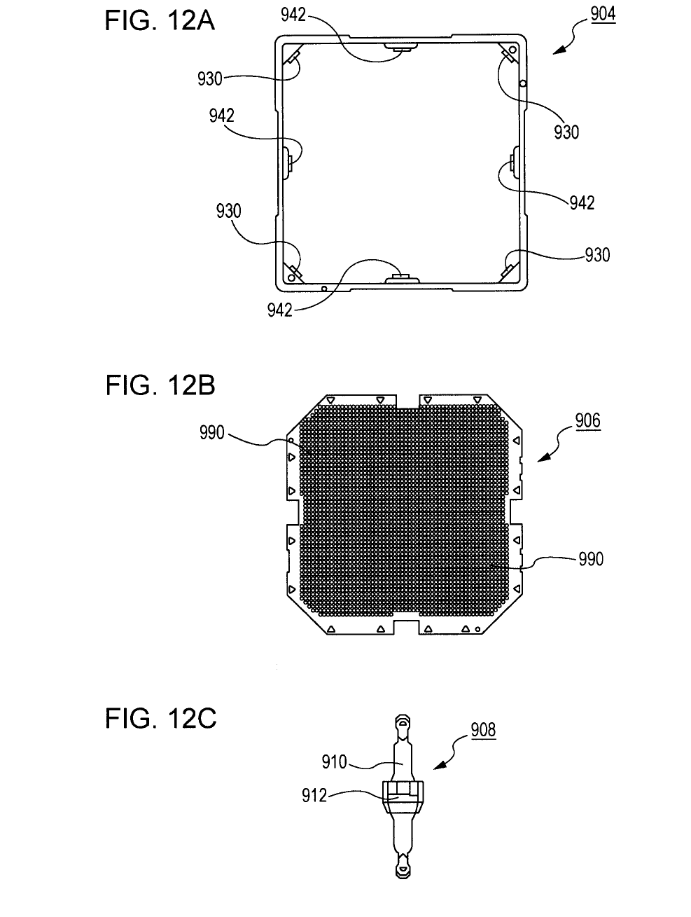

FIG. 13 is an exploded perspective view for illustrating an electronic component socket according to an exemplary embodiment of the present disclosure;

FIGS. 14A and 14B are diagrams for illustrating the electronic component socket according to an exemplary embodiment of the present disclosure, wherein FIG. 14A is a perspective view, and FIG. 14B is a bottom view as viewed from the Z2 side illustrated in FIG. 14A;

FIGS. 15A and 15B are diagrams for illustrating the housing of the electronic component socket according to an exemplary embodiment of the present disclosure, wherein FIG. 15A is a perspective view, and FIG. 15B is a bottom view as viewed from the Z2 side illustrated in FIG. 15A;

FIGS. 16A and 16B are diagrams for illustrating the electronic component socket according to an exemplary embodiment of the present disclosure, wherein FIG. 16A is an enlarged perspective view of the metal plate of the XVI portion illustrated in FIG. 15A, and FIG. 16B is an enlarged top view of the metal plate as viewed from the Z1 side of the XVI portion illustrated in FIG. 15A;

FIGS. 17A through 17C are diagrams for illustrating the electronic component socket according to an exemplary embodiment of the present disclosure, wherein FIG. 17A is a perspective view of a terminal, FIG. 17B is a perspective view of a terminal unit, and FIG. 17C is a back view of the terminal unit as viewed from the Y1 side illustrated in FIG. 13;

FIG. 18 is a diagram for illustrating the electronic component socket according to an exemplary embodiment of the present disclosure, and is an enlarged bottom view of the XVIII portion illustrated in FIG. 14B;

FIG. 19 is a diagram for illustrating the electronic component socket according to an exemplary embodiment of the present disclosure, and is a cross-sectional view taken along the XIX-XIX line illustrated in FIG. 18;

FIGS. 20A and 20B are diagrams for illustrating an electronic component socket according to an exemplary embodiment of the present disclosure, wherein FIG. 20A is a perspective view, and FIG. 20B is a bottom view as viewed from the Z2 side illustrated in FIG. 20A;

FIGS. 21A through 21C are diagrams for illustrating the electronic component socket according to an exemplary embodiment of the present disclosure, wherein FIG. 21A is a perspective view of a terminal, FIG. 21B is a back perspective view of a terminal unit as viewed from the Y1 side illustrated in FIG. 20A, and FIG. 21C is a side view of the terminal unit as viewed from the X1 side illustrated in FIG. 20A;

FIGS. 22A and 22B are diagrams for illustrating the electronic component socket according to an exemplary embodiment of the present disclosure, wherein FIG. 22A is an enlarged bottom view of the XXIIA portion illustrated in FIG. 20B, and FIG. 22B is an enlarged bottom view of the metal plate from which the terminal unit in FIG. 22A is omitted;

FIG. 23 is a plan view for describing an LGA socket according to an exemplary embodiment; and

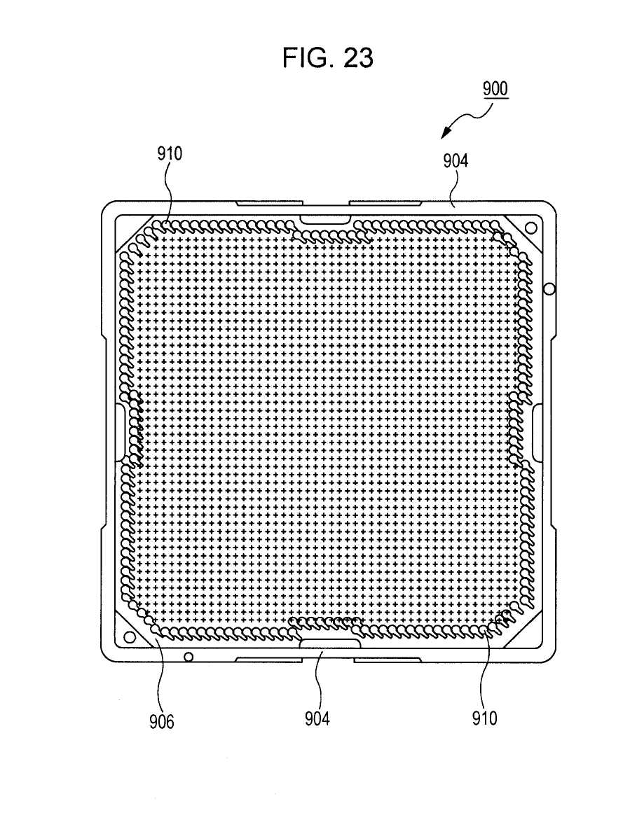

FIGS. 24A through 24C are diagrams for illustrating the LGA socket according to exemplary embodiment, wherein FIG. 24A is a plan view of an insulating housing member, FIG. 24B is a plan view of a substrate, and FIG. 24C is a front view of a contact assembly;

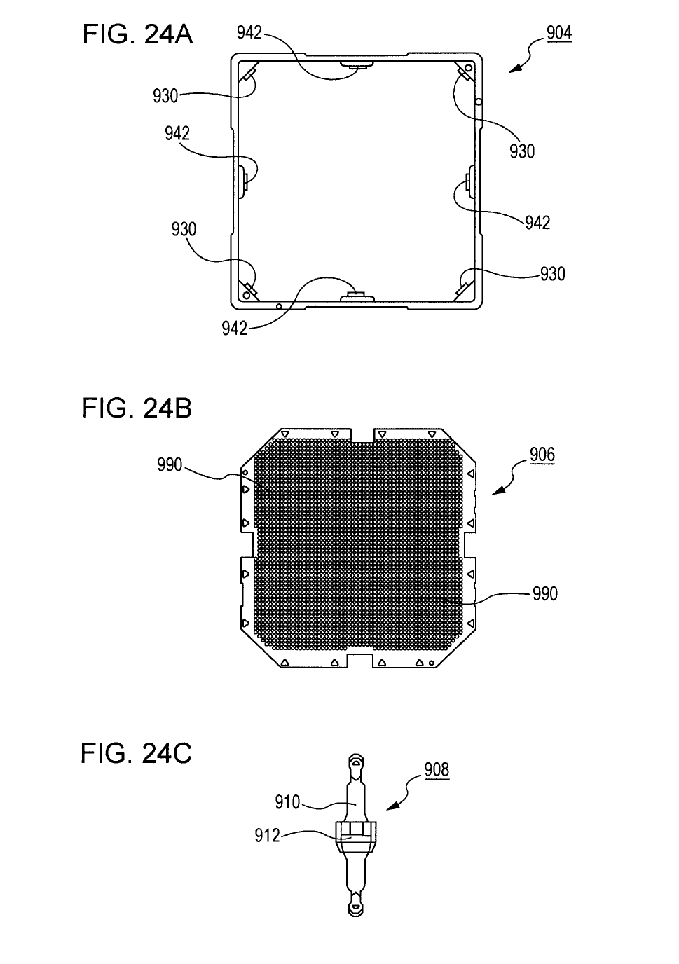

### DETAILED DESCRIPTION OF THE DISCLOSURE

The following description is intended to convey a thorough understanding of the embodiments described by providing a number of specific embodiments and details involving an electronic component socket. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs.

Embodiments of the present disclosure will be described below in detail with reference to the appended drawings.

### First Embodiment

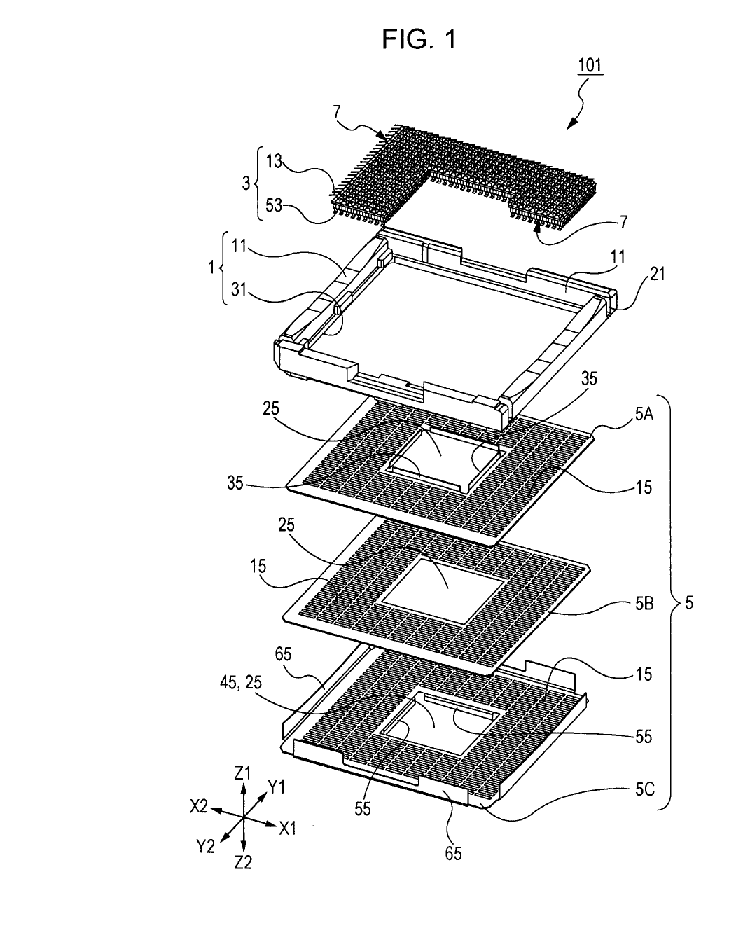

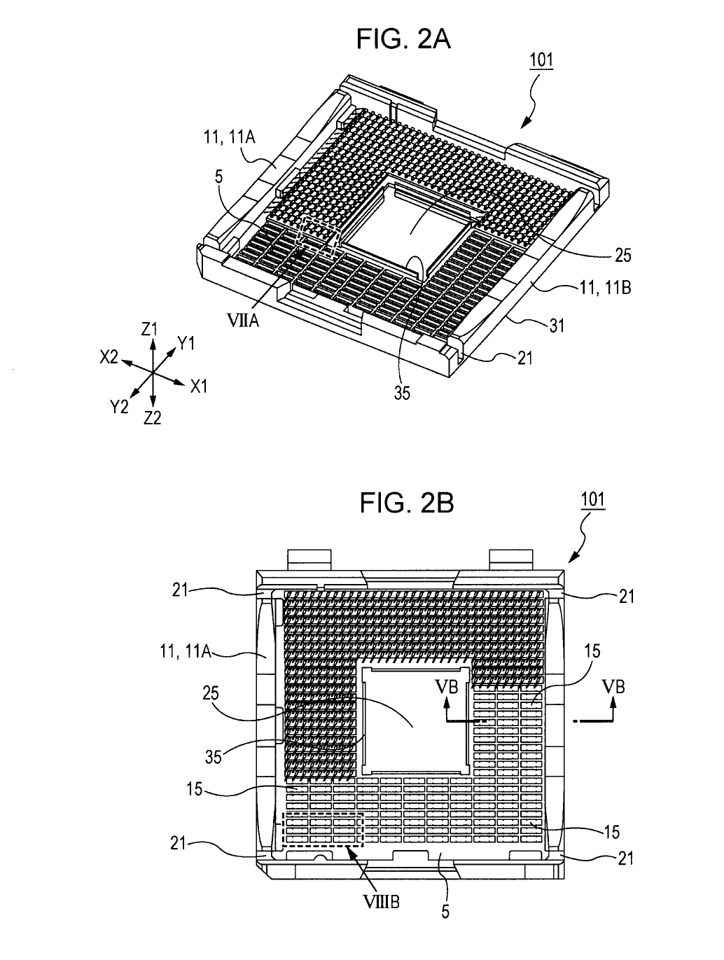

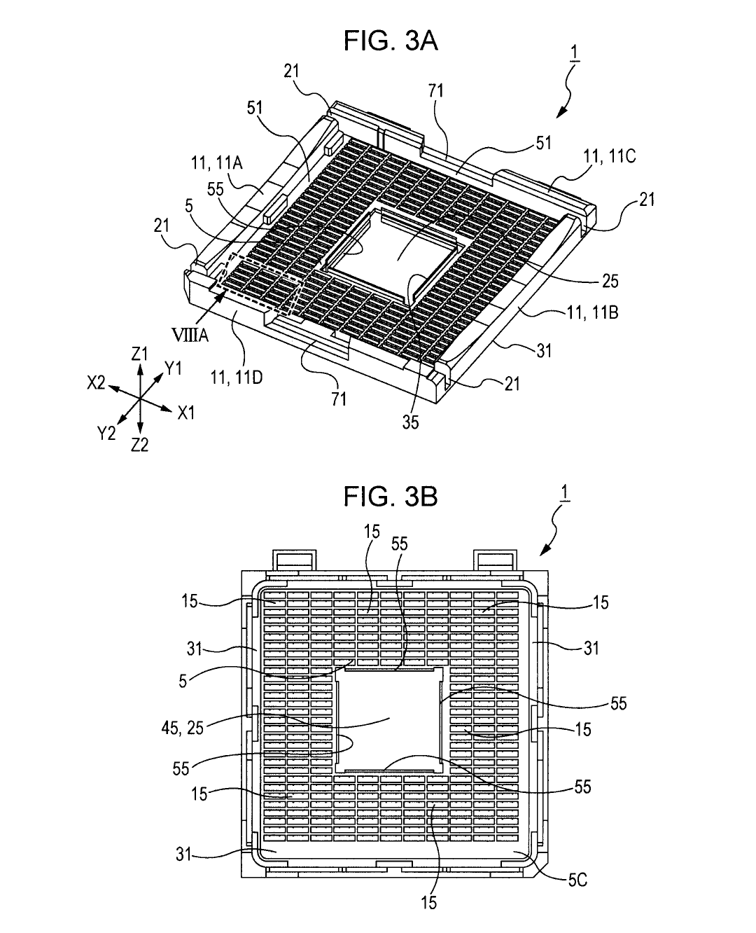

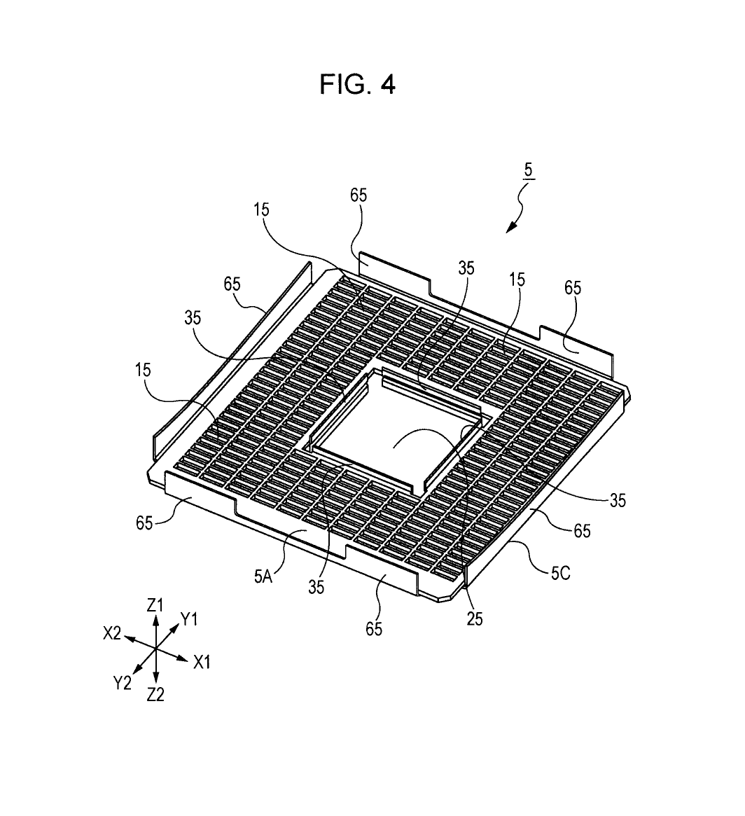

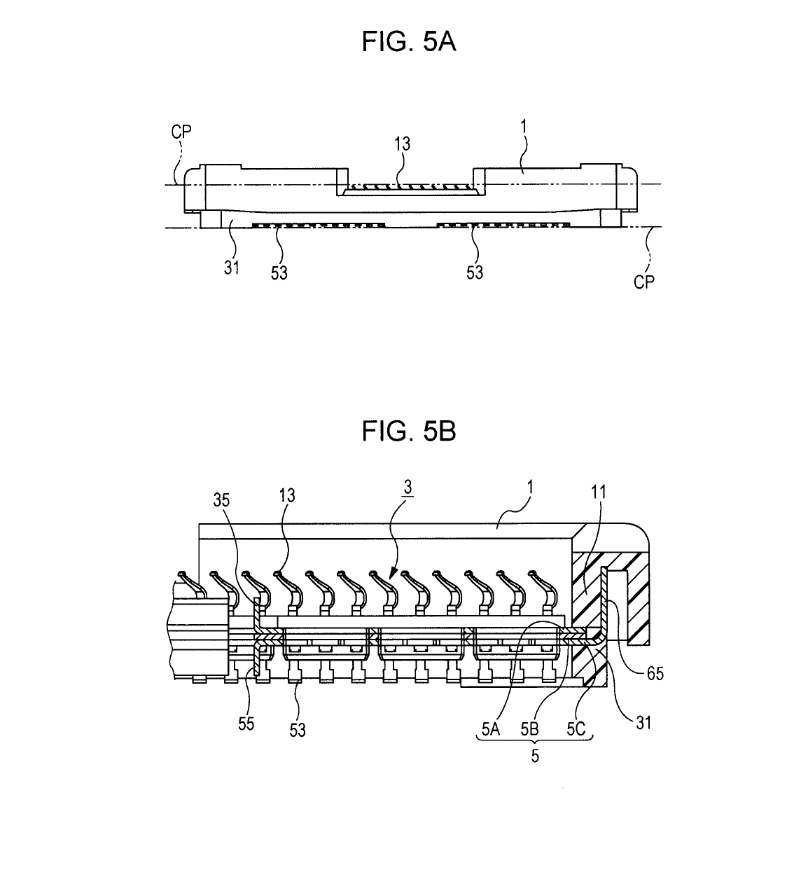

FIG. 1 is an exploded perspective view for describing an electronic component socket 101 according to an exemplary embodiment of the present disclosure. FIGS. 2A and 2B are diagrams for describing the electronic component socket 101 according to an exemplary embodiment of the present disclosure, wherein FIG. 2A is a perspective view, and FIG. 2B is a top view as viewed from the Z1 side illustrated in FIG. 2A. Note that, in order to facilitate description, a portion of a terminal 3 is omitted in FIGS. 1 and 2. FIGS. 3A and 3B are diagrams for describing a housing 1 of the electronic component socket 101 according to an exemplary embodiment of the present disclosure, wherein FIG. 3A is a perspective view, and FIG. 3B is a bottom view as viewed from the Z2 side illustrated in FIG. 3A. FIG. 4 is a diagram for describing the housing 1 of the electronic component socket 101 according to an exemplaryembodiment of the present disclosure, and is a perspective view of a metal plate 5. FIGS. 5A and 5B are diagrams for describing the electronic component socket 101 according to an exemplaryembodiment of the present disclosure, wherein FIG. 5A is a side view as viewed from the Y2 side illustrated in FIG. 2A, and FIG. 5B is a cross-sectional view taken along the VB-VB line illustrated in FIG. 2B.

The electronic component socket 101 according to an exemplaryembodiment of the present disclosure is configured of, as illustrated in FIGS. 1 through 3B, a housing 1, which may include a housing potion 51 surrounded with a side wall 11 and a bottom wall 31, and multiple terminals 3 disposed passing through the bottom wall 31 of the housing 1, and forms a portion of the bottom wall 31 of the housing 1 using a metal plate 5.

The housing 1 may be formed in a square shape as illustrated in FIGS. 3A and 3B, and may form a recessed housing portion 51 surrounded with the side wall 11 and bottom wall 31 so as to house a rectangular electronic component (not illustrated) such as a BGA package or the like. A portion other than the metal plate 5 which forms the bottom wall 31, i.e., a portion of the side wall 11 and bottom wall 31 may be comprised of a synthetic resin material such as LCP (liquid crystal polymer) or the like. The synthetic resin material is employed, and accordingly, manufacturing can readily be performed, for example, by injection molding or the like. Note that, in the event of employing a thermosetting resin such as epoxy resin or the like, manufacturing can readily be performed by transfer molding.

Also, with the side wall 11 of the housing 1, as illustrated in FIGS. 2A through 3B, two slits 21 may be formed on both sides of facing side walls (11A, 11B), respectively. Therefore, as compared to a case where the side wall 11 is formed by being connected across the entire length, the side walls (11A, 11B) may not be restricted by the side walls (11C, 11D) of other sides, and accordingly, warpage of the side wall 11 due to thermal expansion or thermal contraction at the time of manufacturing or use can be suppressed. Further, the slits 21 may be formed on both sides of the side walls 11 (11A, 11B), and accordingly, warpage of the side wall 11 can be suppressed in a well-balanced manner.

Also, with the side walls (11C, 11D) of other sides, a notched portion 71 may be provided to the central portion of the side walls (11C, 11D) for facilitating detachment of a rectangular electronic component, or the like. This notched portion 71 also may suppress warpage of the side wall 11 due to thermal expansion or thermal contraction at the time of manufacturing or use. In the event that this notched portion 71 is not provided for convenience of design, a slit may be provided around the center of the side walls (11C, 11D).

The metal plate 5 may be formed in a square shape as illustrated in FIG. 4, and may include multiple through-holes 15 for housing later-described multiple terminals 3, and the multiple through-holes 15 may be disposed in an array shape. Also, bent portions 65 which may be formed by a portion of the metal plate 5 being bent in the upward side (Z1 side) may be provided to the periphery of the metal plate 5.

Also, an opening 25 may be provided to the central portion of the metal plate 5, and may include a protruding portion 35 extended toward the housing portion 51 side (Z1 side) around the opening 25. Therefore, the bending strength of the planar-shaped metal plate 5 can be improved. Thus, warpage of the entire housing 1 can be suppressed by the metal plate 5 with the improved bending strength. Also, as illustrated in FIG. 5B, with the protruding portion 35, the bent height thereof is lower than the tip height position of the terminal 3 so as not to impede with housing of an electronic component. Note that the metal plate 5 may be manufactured using a metal mold by subjecting a thin plate made up of iron alloy to bending or punching.

Also, with the metal plate 5, as illustrated in FIGS. 3A, 3B, and 5B, the peripheral portion of the metal plate 5 may be embedded in the housing 1, and accordingly, this metal plate 5 may reinforce the synthetic resin portion of the housing 1, and consequently, the bending strength of the entire housing 1 can be improved. Therefore, according to this metal plate 5, warpage of the entire housing 1 caused by influence due to heat at the time of manufacturing or use of the electronic component socket 101 can be suppressed. Further, the bent portions 65 of the metal plate 5 may be embedded in the side wall 11 of the housing 1, and accordingly, warpage of the side wall 11 of the housing 1 can be suppressed by the metal plate 5.

As described above, to suppress warpage of the entire housing 1 caused by influence due to heat at the time of manufacturing or use of the electronic component socket leads to suppress deterioration in the coplanarity CP of a contact portion 13 and a connection portion 53 of the multiple terminals 3 illustrated in FIG. 5A since the multiple terminals 3 may be disposed passing through the through-holes 15 of the metal plate 5 making up a portion of the bottom wall 31 of the housing 1. Accordingly, the electronic component socket 101 according to the present embodiment of the present disclosure can provide an electronic component socket whereby improvement in the coplanarity of the terminals 3 can be realized by suppressing deformation such as warpage of the housing 1 due to heat at the time of manufacturing or use, or the like.

Also, a method for embedding the above metal plate 5 in the housing 1 may be achieved by insert molding. Therefore, the housing 1 with a portion of the bottom wall 31 as metal can readily be formed. Thus, manufacturing can readily be performed, and manufacturing cost can be suppressed.

Also, the metal plate 5 of the electronic component socket 101 according to the present embodiment of the present invention may be, as illustrated in FIG. 1, made up of the three sheets of metal materials (5A, 5B, 5C), as illustrated in FIG. 1. Therefore, as compared to a case where a metal plate made up of one sheet of metal material, even in the case of the same thickness, the metal plate 5 may be made up of multiple sheets of metal materials being overlaid, and accordingly, the bending strength of the planar-shaped metal plate 5 can further be improved. Thus, the coplanarity between the contact portions 13 and the connection portions 53 of the multiple terminals 3 can be improved. Also, at the time of hole drilling of the through-holes 15 as to the metal plate 5, hole drilling with a thinner metal material can improve the flatness precision of the worked surface of a through-hole 15 to be subjected to hole drilling, and accordingly, at the time of disposing the terminals 3, alleviation of the inclination of the terminals 3, and layout precision between the terminals 3 can further be improved.

Also, the protruding portions 35 may be formed as to a metal material 5A positioned most upwards which is one of multiple (three) metal materials (5A, 5B, 5C). Therefore, at the time of an electronic component being disposed in the housing portion 51, the protruding portions 35 can come into contact with the lower surface of the electronic component. Thus, the protruding portions 35 may serve as a stopper of the electronic component, and damage of the contact portions 13 of the terminals 3 due to excessive contact pressure of the electrodes of the electronic component can be prevented.

Also, as illustrated in FIGS. 1, 3A, and 3B, a hole 45 may be provided to the central portion of the metal material 5C positioned most downwards, and downward protrusions 55 extended toward a circuit substrate side (Z2 side) are formed in the circumference of the hole 45. Thus, the bending strength of the metal plate 5 can be improved. Therefore, warpage of the side wall 11 of the housing 1 can be suppressed by the metal plate 5 with improved bending strength. Also, as illustrated in FIG. 5B, with the downward protrusions 55, the bent heights thereof may be lower than the tip height positions of the terminals 3 so as not to prevent connection between the terminals 3 and the circuit substrate.

As described above, with the metal plate 5, the bent portions 65 to be embedded in the side wall 11 in the circumference of the metal material 5C may be provided to the metal material 5C positioned most downwards, and also the downward protrusions 55 extended toward the circuit substrate side (Z2 side) in the circumference of the hole 45 of the central portion of the metal material 5C are provided to the metal material 5C positioned most downwards. On the other hand, the protruding portions 35 extended toward the housing portion 51 side (Z1 side) in the circumference of the opening 25 of the central portion of the metal material 5A may be provided to the metal material 5A positioned most upwards, and the metal material 5B is disposed between the metal material 5A and the metal material 5C. Therefore, the metal plate 5 may be made up of at least three layers or more of metal materials, and the functions of the metal materials are shared, whereby the electronic component socket 101 can be formed small.

Also, the bent portions 65 to be embedded in the side wall 11 may be provided to only the metal material 5C positioned most downwards which may be one of the multiple metal materials, and accordingly, the strength of the side wall 11 can be improved without thickening the thickness of the side wall 11. Therefore, warpage of the side wall 11 of the housing 1 can be suppressed by the bent portions 65 of the metal material 5C. Thus, the coplanarity between the contact portions 13 and the connection portions 53 of the multiple terminals 3 can further be improved.

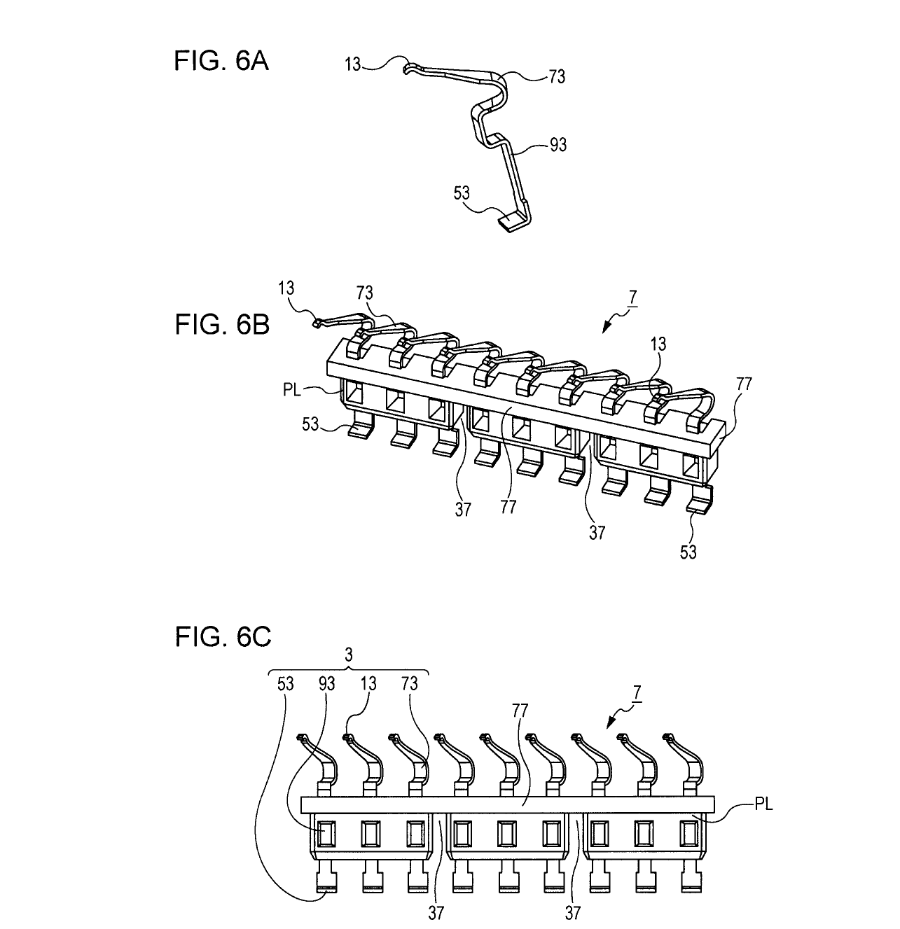

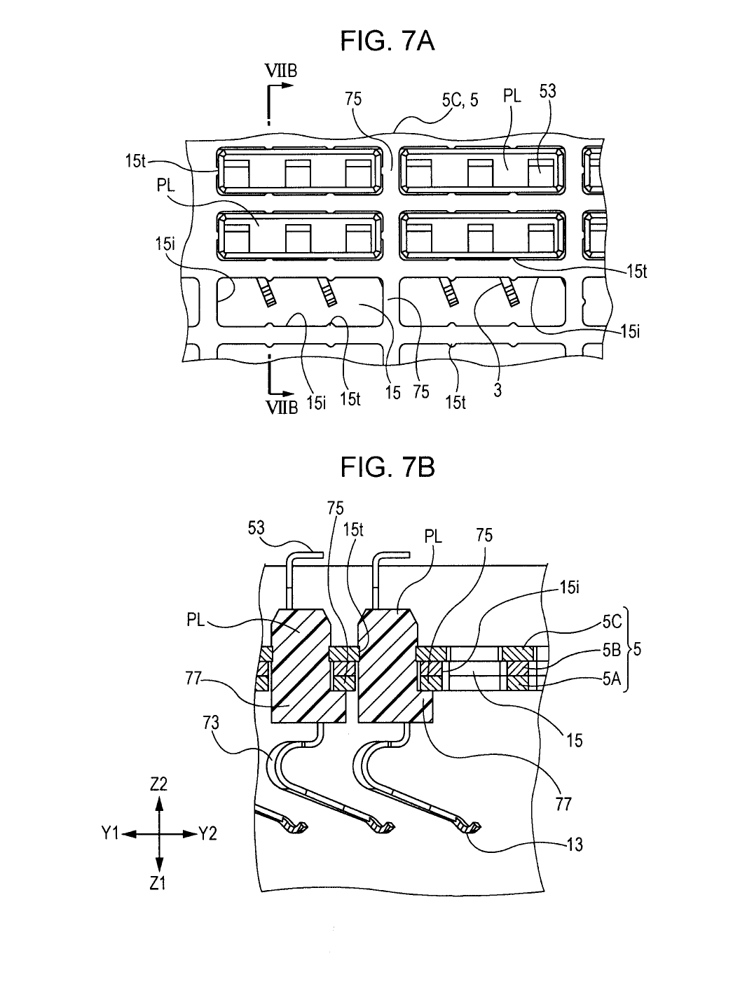

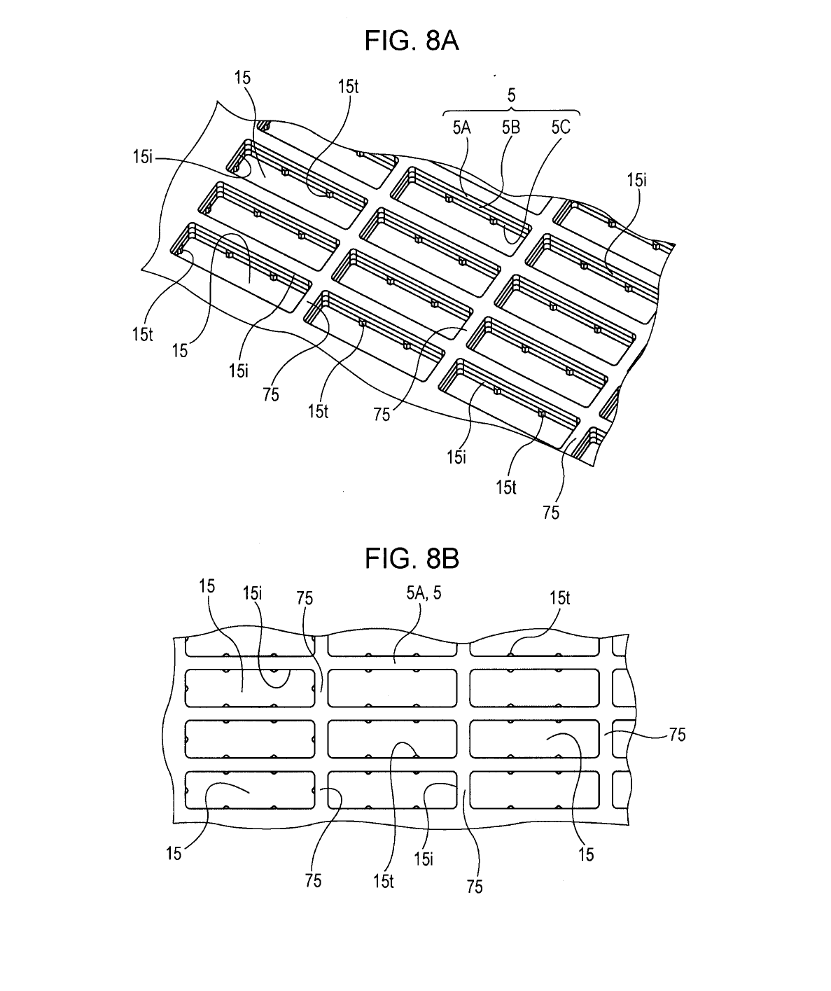

FIGS. 6A through 6C are diagrams for describing the electronic component socket 101 according to an exemplary embodiment of the present disclosure, wherein FIG. 6A is a perspective view of a terminal 3, FIG. 6B is a perspective view of a terminal unit 7, and FIG. 6C is a front view of the terminal unit 7 as viewed from the Y2 side illustrated in FIG. 1. FIGS. 7A and 7B are diagrams for describing the electronic component socket 101 according to an exemplary embodiment of the present disclosure, wherein FIG. 7A is an enlarged bottom view as viewed from the Z2 side of the VIIA portion illustrated in FIG. 2A, and FIG. 7B is a cross-sectional view taken along the VIIB-VIIB line illustrated in FIG. 7A. FIGS. 8A and 8B are diagrams for describing the electronic component socket 101 according to an exemplary embodiment of the present disclosure, wherein FIG. 8A is an enlarged perspective view of the metal plate 5 of the VIIIA portion illustrated in FIG. 3A, and FIG. 8B is an enlarged top view of the metal plate 5 of the VIIIB portion illustrated in FIG. 2B.

The terminals 3 may be manufactured in a pin shape by subjecting a thin plate made up of copper alloy to bending or punching using a metal mold, and may include, as illustrated in FIGS. 6A through 6C, a terminal base 93 covered with an insulating resin PL, a contact portion 13 contactable with an electrode (not illustrated) of an electronic component, and a connection portion 53 connectable with a round (not illustrated) of a circuit substrate. With the contact portions 13, in order to come into contact with an electrode of an electronic component to perform electric connection in a sure manner, the tip may be subjected to bending in a protruding shape, and may be formed on the tip portion of an arm-shaped portion 73 having elasticity. Also, in order to perform soldering as to a round of the circuit substrate, the connection portions 53 may be formed by being subjected to bending in an L-letter shape.

Also, with the terminals 3, a portion of the terminal base 93 may be covered with the insulating resin PL, and may be disposed by the portion covered with the insulating resin PL being fitted into a through-hole 15 of the metal plate 5. Therefore, multiple terminals 3 can be held at the metal plate 5 which may have great bending strength in a sure manner. Thus, the coplanarity of the contact portions 13 and connection portions 53 of the multiple terminals 3 can further be improved.

Also, with the terminals 3 of the electronic component socket 101 according to the present embodiment of the present disclosure, as illustrated in FIGS. 6B and 6C, some of the multiple terminals 3 may be covered and liked with the insulating resin PL to form a terminal unit 7 so that the terminals 3 thereof are not electrically connected. Thus, assembly properties can be improved as compared to a case where the terminals 3 covered with the insulating resin PL may be disposed by being fitted into the through-holes 15 of the metal plate 5 one at a time. Note that, though the terminals 3 illustrated in FIGS. 6B and 6C are made up of nine terminals 3, the number of the terminals 3 is not restricted to nine as long as the number of the terminals 3 is greater than one.

With the terminal units 7, the multiple terminals 3 may be embedded in the insulating resin PL by insert molding using a synthetic resin material such as LCP (liquid crystal polymer) or the like as the insulating resin PL. Also, the terminal units 7 may be blocks combined for every two or more terminals 3 (three in the example in FIGS. 6B and 6C), and three blocks are linked with a liking member 77. A groove 37 may be formed between the three blocks, and at the time of mounting the terminal unit 7 as to the through-holes 15, folds a partition 75 which partitions the through-holes 15 of the metal plate 5 illustrated in FIGS. 8A and 8B.

Upon mounting the terminal unit 7 having the exemplary nine terminals 3 illustrated in FIGS. 6B and 6C on the metal plate 5, three terminals 3 may be housed in one through-hole 15, the portion of the insulating resin PL may be fitted into three through-holes 15 sandwiching two partitions 75 therebetween, and consequently, the nine terminals 3 may be disposed passing through the bottom wall 31 of the housing 1. Therefore, as compared to a case where one train of the through-holes 15 is formed and the terminal unit 7 is mounted, there may be a partition 75 between a through-hole 15 and another through-hole 15, and accordingly, the strength of the metal plate 5 may increase, and also flexure of the terminal unit 7 may be suppressed. Thus, the coplanarity of the contact portions 13 and connection portions 53 of the multiple terminals 3 can further be improved.

Also, as illustrated in FIGS. 7A through 8B, protruding portions 15t for positioning a terminal unit 7 may be formed on inner walls 15i of the through-holes 15 of the metal plate 5. The protruding portions 15t illustrated in FIGS. 7B and 8C may be provided to only the metal plate 5C of the metal plate 5, for example. This is because at the time of mounting the terminal unit 7 on the metal plate 5 from the upward side (Z1 side), while the insulating resins PL of the terminal units 7 are in contact with the protruding portions 15t of the metal plate 5C using the through-holes 15 of the metal plates 5A and 5B as guide holes, these are strongly fitted. Finally, as illustrated in FIG. 7B, the upper surfaces (Z1 side) of the partitions 75 may be in contact with the lower faces (Z2 side) of the linking members 77, and the terminal units 7 may be mounted on the metal plate 5. Thus, the positioning precision of the terminal units 7 can be improved.

As described above, with the electronic component socket 101 according to the present embodiment of the present disclosure, a part of the metal plate 5 may be embedded in the housing 1, and accordingly, this metal plate 5 may reinforce the synthetic resin portion, and consequently, the bending strength of the entire housing 1 can be improved. Therefore, warpage of the entire housing 1 caused by influence due to heat at the time of manufacturing or use of the electronic component socket 101 can be suppressed by this metal plate 5. Thus, the coplanarity of the contact portions 13 and connection portions 53 of the multiple terminals 3 housed in the through-holes 15 of the metal plate 5 can further be improved. Accordingly, the electronic component socket 101 according to the present embodiment of the present disclosure can provide an electronic component socket whereby improvement in the coplanarity of the terminals 3 can be realized while suppressing deformation such as warpage of the housing 1 due to heat at the time of manufacturing or use.

Also, the metal plate 5 may be embedded in the side wall 11 of the housing 1, and accordingly, warpage of the side wall 11 of the housing 1 can be suppressed by this metal plate 5. Thus, the coplanarity of the contact portions 13 and connection portions 53 of the multiple terminals 3 can further be improved.

Also, the protruding portions 35 extended toward the housing portion 51 side may be provided to the circumference of the opening 25 provided to the central portion of the metal plate 5 embedded in the bottom wall 31, and accordingly, the bending strength of the planar-shaped metal plate 5 can be improved. Thus, warpage of the entire housing 1 can be suppressed by the metal plate 5 with improved bending strength, and the coplanarity of the contact portions 13 and connection portions 53 of the multiple terminals 3 can further be improved.

Also, the side wall 11 where the slits 21 are formed may have an unrestricted configuration, and accordingly, as compared to a case where the side wall 11 is formed in a manner connected across the entire length, warpage of the side wall 11 due to thermal expansion or thermal contraction at the time of manufacturing or use can be suppressed. Thus, the coplanarity of the contact portions 13 and connection portions 53 of the multiple terminals 3 can further be improved.

Also, the slits 21 may be formed on both sides of the side wall 11 in one of a pair of the side walls 11 facing, and accordingly, warpage of the side wall 11 can be suppressed in a well-balanced manner. Thus, the coplanarity of the contact portions 13 and connection portions 53 of the multiple terminals 3 can further be improved.

Also, the insulating resin PL covering a part of the terminals 3 may be disposed so as to be fitted into the through-holes 15 of the metal plate 5, and accordingly, the multiple terminals 3 can be held at the metal plate 5 with strong bending strength in a sure manner. Thus, the coplanarity of the contact portions 13 and connection portions 53 of the multiple terminals 3 can further be improved.

The multiple terminals 3 may be covered and liked with the insulating resin PL, thereby forming a terminal unit 7, and accordingly, assembly properties can be improved as compared to a case where the terminals 3 are disposed in the through-holes 15 of the metal plate 5 one at a time.

Also, there may be a partition 75 between a through-hole 15 and another through-hole 15, and accordingly, as compared to a case where a terminal unit 7 is mounted by forming a train of through-holes 15, the strength of the metal plate 5 may be improved, and also flexure of the terminal unit 7 is suppressed. Thus, the coplanarity of the contact portions 13 and connection portions 53 of the multiple terminals 3 can further be improved.

Also, the protruding portions 15t for positioning the terminal units 7 may be formed in the inner walls 15i of the through-holes 15 of the metal plate 5, and accordingly, positioning precision of the terminal units 7 can be improved.

Also, the bent portions 65 to be embedded in the side wall 11 may be provided to only the metal material 5C positioned most downwards which is one of the multiple metal materials, and accordingly, the strength of the side wall 11 can be improved without thickening the thickness of the side wall 11. Thus, warpage of the side wall 11 of the housing 1 can be suppressed by the bent portions 65 of the metal material 5C, and the coplanarity between the contact portions 13 and the connection portions 53 of the multiple terminals 3 can further be improved.

Also, the bent portions 65 to be embedded in the side wall 11 in the circumference of the metal material 5C may be provided to the metal material 5C positioned most downwards, and also the downward protrusions 55 extended toward the circuit substrate side (Z2 side) in the circumference of the hole 45 of the central portion of the metal material 5C may be provided to the metal material 5C positioned most downwards. On the other hand, the protruding portions 35 extended toward the housing portion 51 side (Z1 side) in the circumference of the opening 25 of the central portion of the metal material 5A may be provided to the metal material 5A positioned most upwards, and the metal material 5B may be disposed between the metal material 5A and the metal material 5C. Therefore, the metal plate 5 may be made up of at least three layers or more of metal materials, and the functions of the metal materials may be shared, whereby the electronic component socket 101 can be formed small.

Also, the downward protrusions 55 may be provided toward the downward side in the circumference of the hole 45 provided to the central portion of the metal plate 5 of the bottom wall 31, and accordingly, the bending strength of the planar-shaped metal plate 5 can be improved. Thus, warpage of the side wall 11 of the housing 1 can be suppressed by the metal plate 5 with improved bending strength, and the coplanarity between the contact portions 13 and the connection portions 53 of the multiple terminals 3 can further be improved.

Also, the protruding portions 35 may be formed as to the metal material 5A positioned most upwards which is one of multiple (three) metal materials (5A, 5B, 5C). Therefore, at the time of an electronic component being disposed in the housing portion 51, the protruding portions 35 may come into contact with the lower surface of the electronic component. Thus, the protruding portions 35 may serve as a stopper of the electronic component, and damage of the contact portions 13 of the terminals 3 due to excessive contact pressure of an electrode of the electronic component can be prevented.

Also, the metal plate 5 may be embedded in the housing 1 by insert molding, and accordingly, the housing 1 with a portion of the bottom wall 31 as metal can readily be formed. Thus, manufacturing can readily be performed, and manufacturing cost can be suppressed.

Note that the present disclosure is not restricted to the above embodiment, and can be carried out by being modified such as the following, and these embodiments also belong to the technical scope of the present disclosure.

### Modification 1

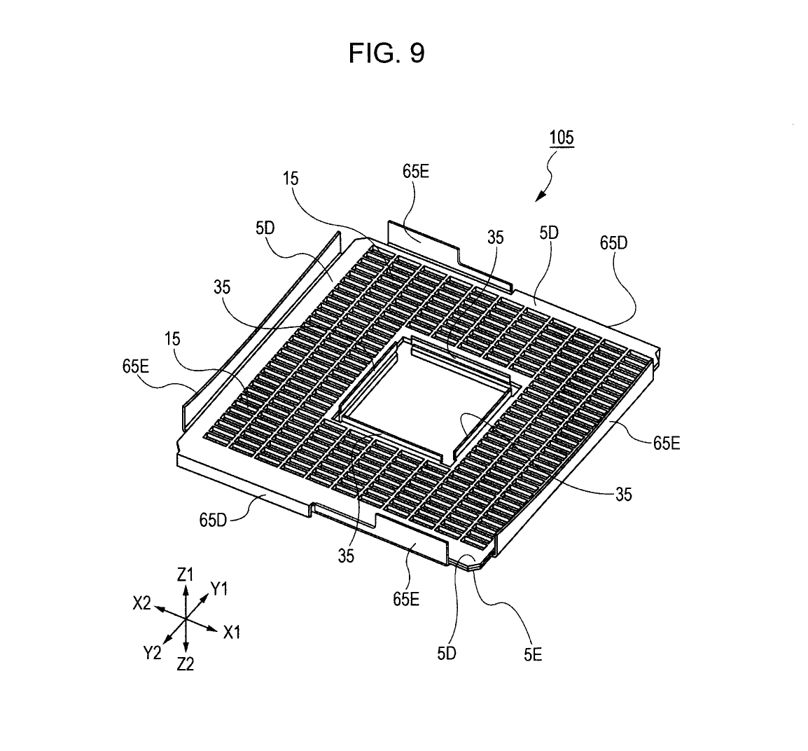

FIG. 9 is a diagram for describing a modification 1 of the electronic component socket 101 according to an exemplary embodiment of the present disclosure, and is a perspective view of a metal plate 105.

With the first embodiment described above, an arrangement has been made wherein the bent portions 65 may be provided to only the metal material 5C of the metal plate 5, and may be embedded on the upward side (Z1 side) of the side wall 11 of the housing 1. As illustrated in FIG. 9, an arrangement may be made wherein bent portions 65E extended toward the upward side may be provided to the metal material 5E positioned most downwards, and bent portions 65D extended toward the downward side may be provided to the metal material 5D positioned most upwards, and may be embedded in the side wall 11 of the housing 1. Therefore, with the metal plate 105, the multiple metal materials (5D, 5E) may be extended and embedded by being vertically divided within the side wall 11, and accordingly, the strength of the side wall 11 can further be improved without thickening the thickness of the side wall 11. Thus, warpage of the side wall 11 of the housing 1 can be suppressed by the metal plate 105, and the coplanarity between the contact portions 13 and the connection portions 53 of the multiple terminals 3 can further be improved. Also, though not illustrated in the drawing, as another arrangement providing the same advantage, an arrangement may be made wherein, bent portions toward the upward side equivalent to the bent portions 65E from the metal material 5D positioned most upwards illustrated in FIG. 9 are formed, and bent portions toward the downward side equivalent to the bent portions 65D from the metal material 5E positioned most downwards may be formed.

### Modification 2

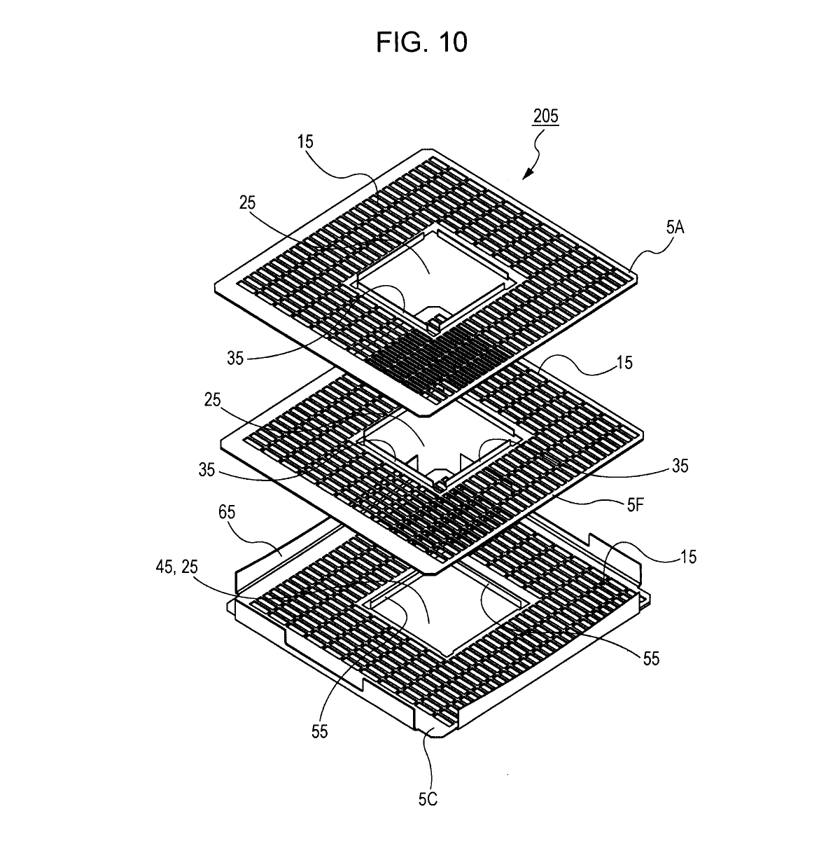

FIG. 10 is a diagram for describing a modification 2 of the electronic component socket 101 according to an exemplary embodiment of the present disclosure, and is an exploded perspective view of a metal plate 205.

With the above-described embodiment, an arrangement has been made wherein the protruding portions 35 are provided to only the metal material 5A positioned most upwards of the metal plate 5, but an arrangement may be provided wherein the protruding portions 35 may be provided to the metal material 5F positioned between the metal material 5A and the metal material 5C. Therefore, the protruding portions 35 may be formed on the multiple sheets of metal materials (5A, 5F), and accordingly, the bending strength of the planar-shaped metal plate 205 can further be improved. Thus, warpage of the entire housing 1 can be suppressed by the metal plate 205 with improved bending strength, and the coplanarity between the contact portions 13 and the connection portions 53 of the multiple terminals 3 can further be improved. Note that in the event of employing further many metal materials, the protruding portions 35 may be provided as appropriate.

### Modification 3

With the first embodiment described above, an arrangement has been made wherein the protruding portions 15t for positioning of the terminal units 7 may be provided to the inner walls 15i of the through-holes 15 of the metal plate 5, but an arrangement may be made wherein recessed portions for positioning of the terminal units 7 are formed. In this case, a protruding portion to be fitted into a recessed portion may be provided to the insulating resins PL of the terminal units 7, and this protruding portion has a somewhat greater shape than that of the recessed portion so as to obtain strong fitting. Thus, the recessed portions for positioning of the terminal units 7 may be formed, and accordingly, the positioning precision of the terminal units 7 can be improved.

With the above-described embodiment, though the multiple terminals 3 are disposed passing through the bottom wall 31 of the housing 1 by the terminal units 7 being fitted into the through-holes 15 of the metal plate 5 suitably using the terminal units 7, an arrangement may be made wherein one terminal 3 is covered with the insulating resin PL, and the portion of the insulating resin PL is fitted into the through-holes 15 of the metal plate 5, and a single terminal 3 is sequentially disposed.

With the above-described embodiment, an arrangement has been made wherein the terminals 3 are disposed by the portion covered with the insulating resin PL being fitted into the through-holes 15 of the metal plate 5, but an arrangement also may be made wherein the insulating resin PL may be provided to a part or all of the inner wall 15i of the through-holes 15 of the metal plate 5, terminals may be pressed thereinto from back, and the terminals are disposed passing through the bottom wall 31 of the housing 1. At this time, the terminals may have a shape whereby the terminals can readily be pressed thereinto, e.g., a shape with one side having a linear shape.

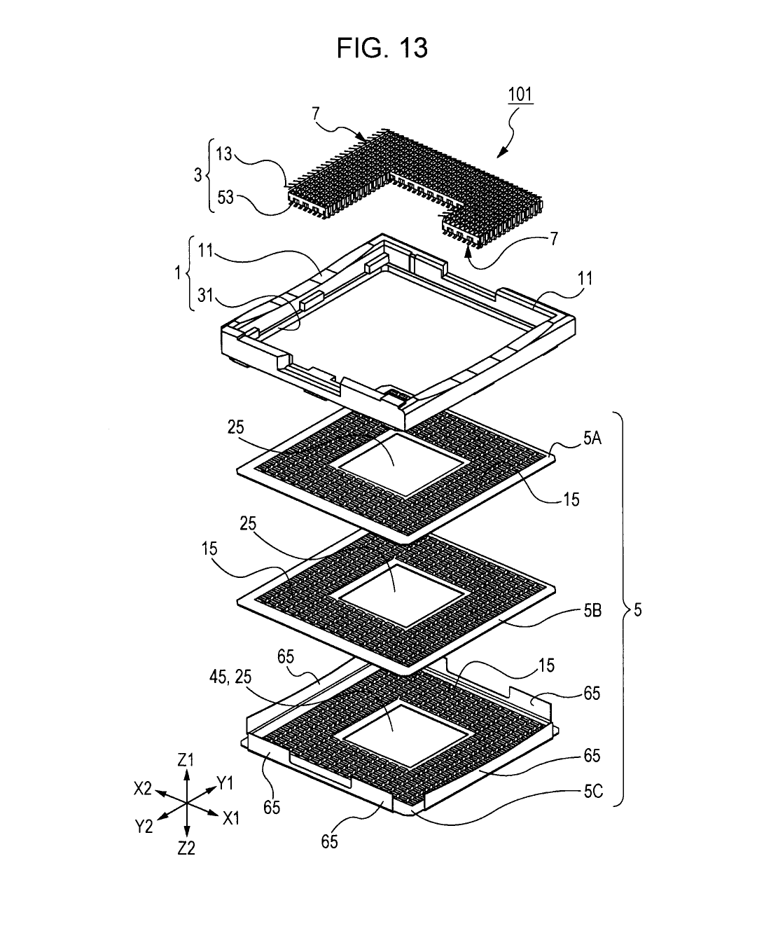

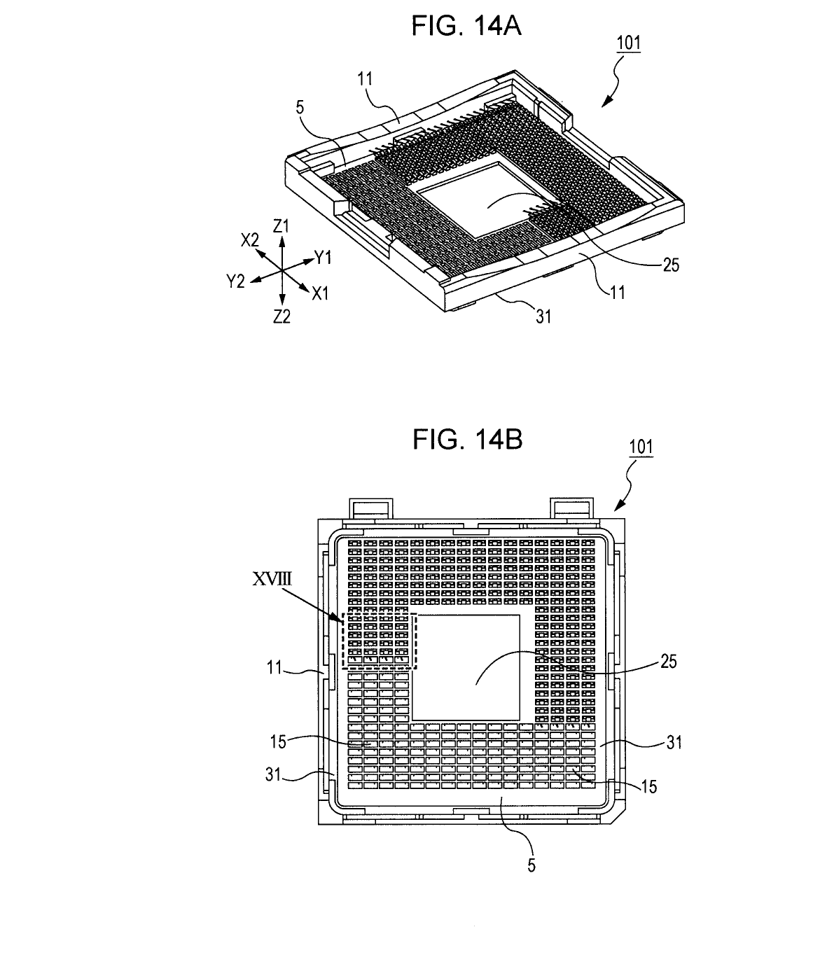

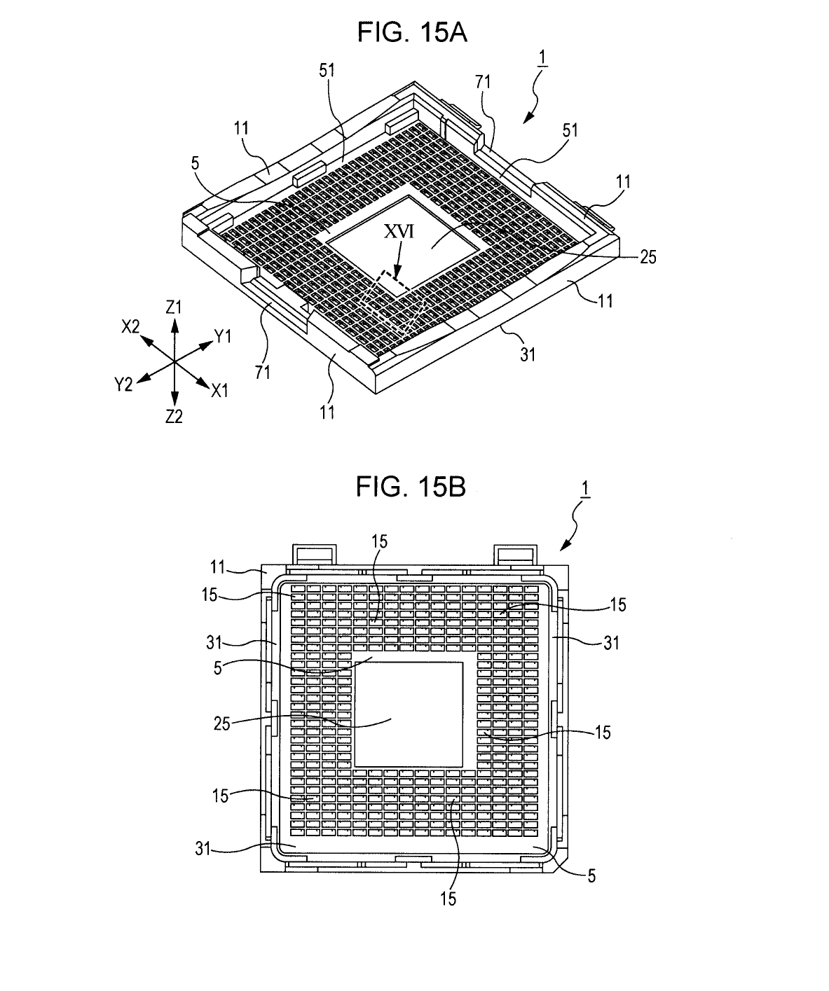

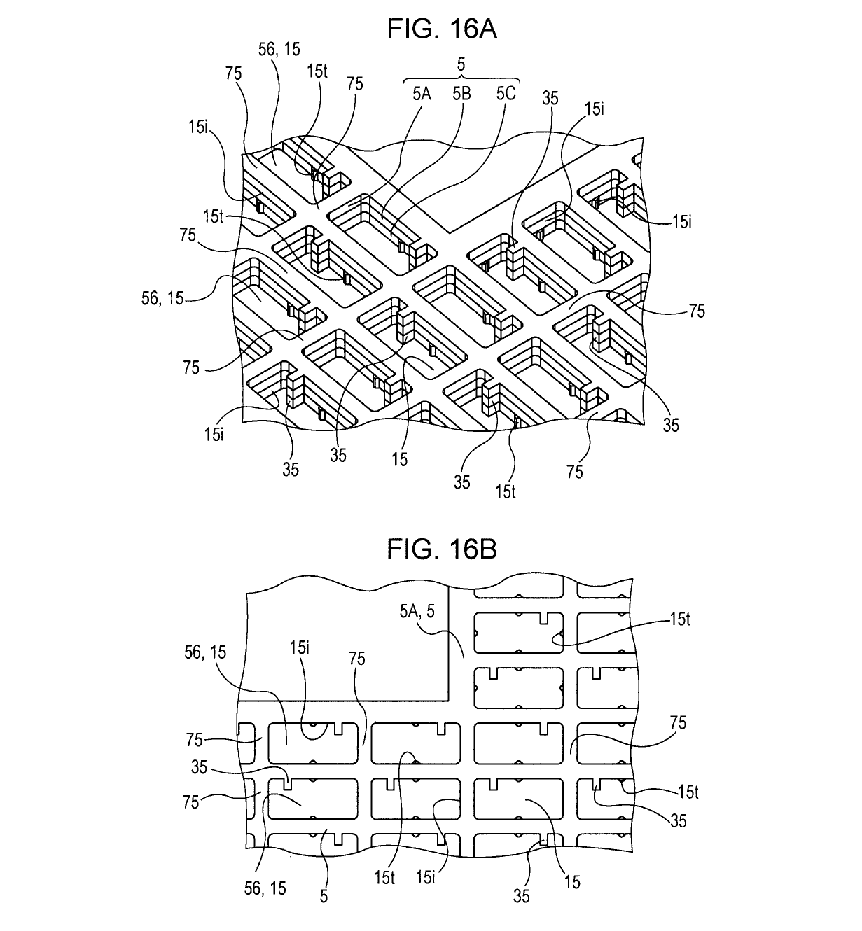

FIG. 13 is an exploded perspective view for describing an electronic component socket 101 according to an exemplary embodiment of the present disclosure. FIGS. 14A and 14B are diagrams for describing the electronic component socket 101 according to an exemplary embodiment of the present disclosure, wherein FIG. 14A is a perspective view, and FIG. 14B is a bottom view as viewed from the Z2 side illustrated in FIG. 14A. Note that, in FIGS. 13 through 14B, in order to facilitate description, a portion of the terminal 3 is omitted. FIGS. 15A and 15B are diagrams for describing the housing 1 of the electronic component socket 101 according to an exemplary embodiment of the present disclosure, wherein FIG. 15A is a perspective view, and FIG. 15B is a bottom view as viewed from the Z2 side illustrated in FIG. 15A. FIGS. 16A and 16B are diagrams for describing the electronic component socket 101 according to an exemplary embodiment of the present disclosure, wherein FIG. 16A is an enlarged perspective view of the metal plate 5 of the XVI portion illustrated in FIG. 15A, and FIG. 16B is an enlarged top view of the metal plate 5 as viewed from the Z1 side of the XVI portion illustrated in FIG. 15A.

The electronic component socket 101 according to this embodiment of the present disclosure may be configured of, as illustrated in FIGS. 13 through 15B, the housing 1 having the housing portion 51 surrounded with the side wall 11 and bottom wall 31, and the multiple terminals 3 disposed passing through the bottom wall 31 of the housing 1, and a portion of the bottom wall 31 of the housing 1 may be formed with the metal plate 5.

The housing 1 may be formed in a square shape as illustrated in FIGS. 15A and 15B, and may form a recessed housing portion 51 surrounded with the side wall 11 and bottom wall 31 may be formed so as to house a rectangular electronic component (not illustrated) such as a BGA package or the like. A portion other than the metal plate 5 which makes up the bottom wall 31, i.e., a portion of the side wall 11 and bottom wall 31 may employ a synthetic resin material such as LCP (liquid crystal polymer) or the like. The synthetic resin material may be employed, and accordingly, the housing 1 can readily be manufactured, for example, by injection molding or the like. Note that, in the event of employing a thermosetting resin such as an epoxy resin or the like, the housing 1 can readily be manufactured by transfer molding.

Also, with the side wall 11 of the housing 1, the notched portion 71 may be provided to the central portion thereof for facilitating detachment of a rectangular electronic component, or the like. However, this notched portion 71 may be adjusted so as to agree with the specification of an electronic component to be stored, and is not restricted to this shape.

The metal plate 5 may be formed in a square shape as illustrated in FIGS. 13 through 15B, and has multiple through-holes 15 for housing later-described multiple terminals 3, and the multiple through-holes 15 may be disposed in an array shape. Also, the bent portions 65 formed by a portion of the metal plate 5 being bent toward the upward side (Z1 side) may be provided at the periphery of the metal plate 5, and the opening 25 is provided to the central portion of the metal plate 5.

Also, the metal plate 5 may be configured of three sheets of metal materials (5A, 5B, 5C) as illustrated in FIG. 13. Therefore, as compared to a metal plate made up of one sheet of metal material, even in the case of the same thickness, the metal plate 5 may be made up of multiple sheets of metal materials being overlaid, and accordingly, the bending strength of the planar-shaped metal plate 5 can further be improved. Also, the above-mentioned opening 25 may be provided to all of the three sheets of metal materials (5A, 5B, 5C), and the above-mentioned bent portions 65 may be provided to only the metal material 5C positioned most downwards. This metal plate 5 may be manufactured using a metal mold by subjecting a thin plate made up of iron alloy to bending or punching.

Also, as illustrated in FIGS. 13 through 15B, the peripheral portion of the metal plate 5 may be embedded in the housing 1, and also the bent portions 65 may be embedded up to the upward side (Z1 side) of the side wall 11 of the housing 1. The peripheral portion of the metal plate 5 may be embedded in the housing 1, and accordingly, this metal plate 5 may reinforce the synthetic resin portion of the housing 1, and consequently, the bending strength of the entire housing 1 can be improved. Therefore, warpage of the entire housing 1 caused by influence due to heat at the time of manufacturing or use of the electronic component socket 101 can be suppressed by this metal plate 5. Further, the bent portions 65 of the metal plate 5 may be embedded up to the upward side (Z1 side) of the side wall 11 of the housing 1, and accordingly, warpage of the side wall 11 of the housing 1 can be suppressed by the metal plate 5.

A method for embedding the above metal plate 5 in the housing 1 may be achieved by, for example, insert molding. Therefore, the housing 1 with a portion of the bottom wall 31 as metal can readily be formed. Thus, manufacturing can readily be performed, and manufacturing cost can be suppressed.

Also, as illustrated in FIGS. 16A and 16B, the protruding portions 35 extended and provided from the inner walls 15i may be formed on the inner walls 15i of the through-holes 15 of the metal plate 5. In order to electrically conduct between a later-described ground terminal G3 and the metal plate 5, the protruding portions 35 illustrated in FIGS. 16A and 16B may be configured of a shape so as to come into contact with the ground terminal G3, and also may be elastic members so as to elastically press the ground terminal G3. Note that, though the protruding portions 35 may be provided to all of the three sheets of metal materials (5A, 5B, 5C) in the same shape, these three sheets of metal materials (5A, 5B, 5C) have electroconductivity, and may be configured by being overlaid, and accordingly, the protruding portions 35 may be provided to at least one of the multiple metal materials for electric conduction.

Also, protruding portions 15t for positioning of a later-described terminal unit 7 may be formed on the inner walls 15i of the through-holes 15 of the metal plate 5. The protruding portions 15t illustrated in FIGS. 16A and 16B may be provided to only the metal material 5C of the meal plate 5.

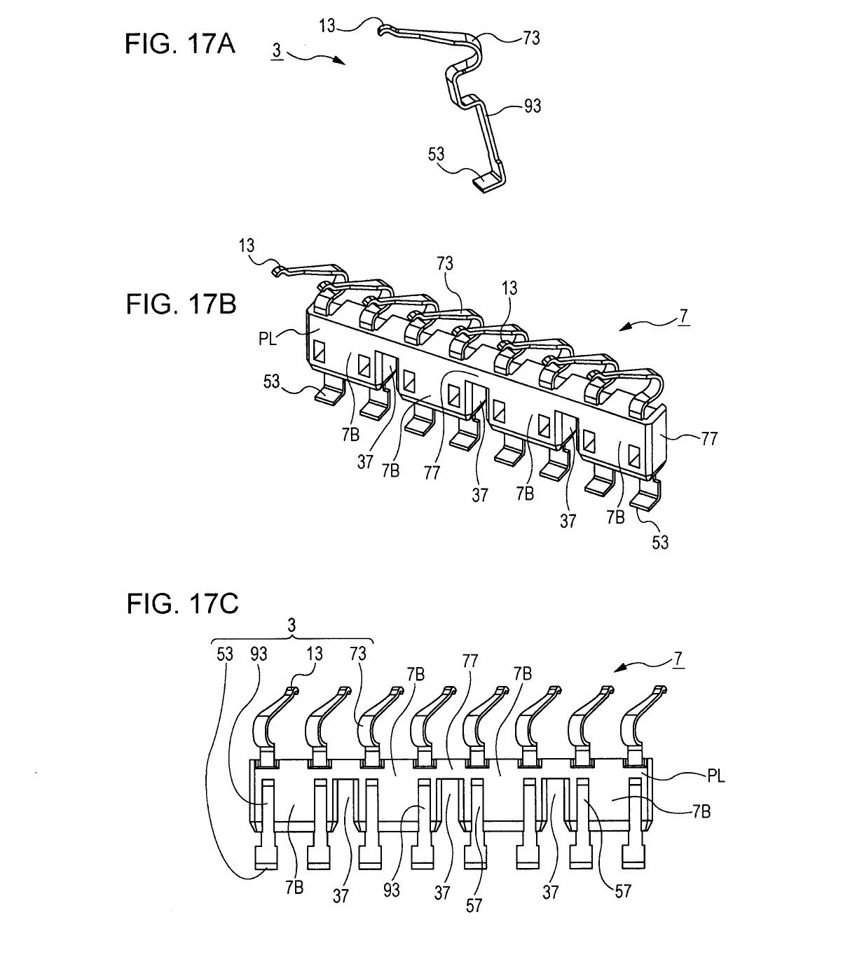

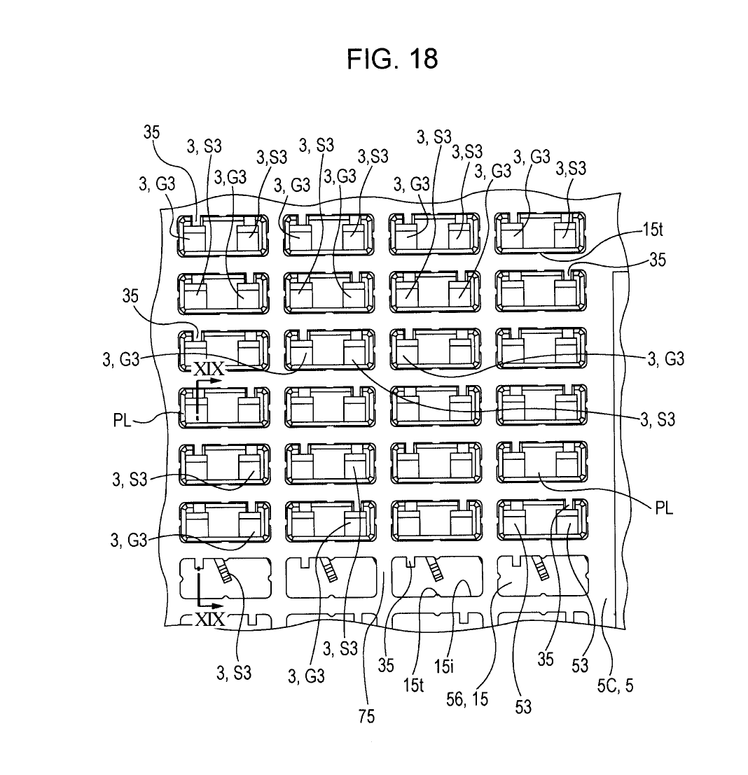

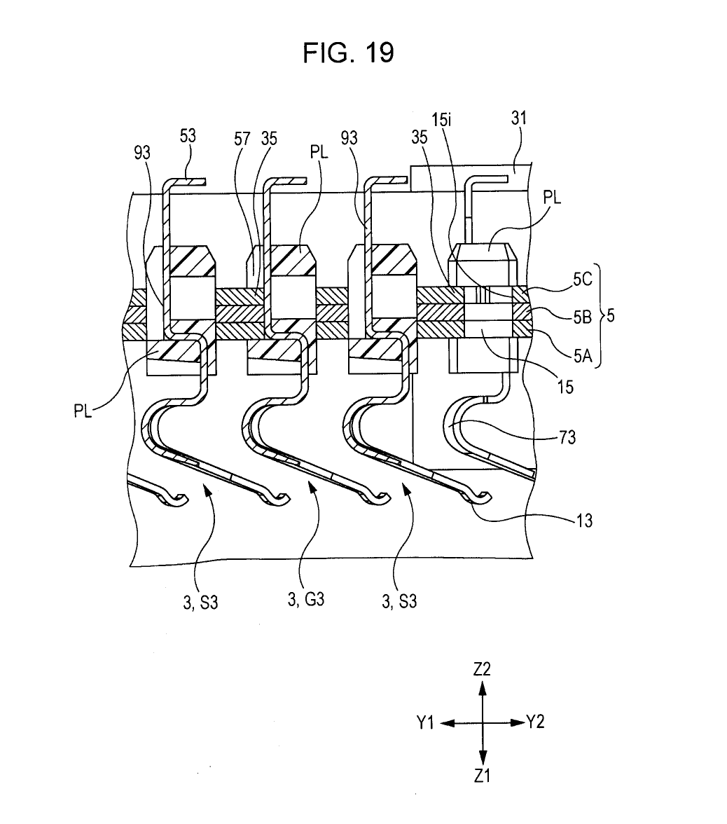

FIGS. 17A through 17C are diagrams for describing the electronic component socket 101 according to an exemplary embodiment of the present disclosure, wherein FIG. 17A is a perspective view of a terminal 3, FIG. 17B is a perspective view of a terminal unit 7, and FIG. 17C is a back view of the terminal unit 7 as viewed from the Y1 side illustrated in FIG. 13. FIG. 18 is a diagram for describing the electronic component socket 101 according to an exemplary embodiment of the present disclosure, and is an enlarged bottom view of the XVIII portion illustrated in FIG. 14B. FIG. 19 is a cross-sectional view taken along the XIX-XIX line illustrated in FIG. 18.

The terminals 3 may be manufactured in a pin shape by subjecting a thin plate made up of copper alloy to bending and punching using a metal mold, and may be configured of, as illustrated in FIGS. 17A through 17C, a terminal base 93 of which a portion is covered with the insulating resin PL, a contact portion 13 contactable with the electrodes of an electronic component (not illustrated), and a connection portion 53 connectable with a round of the circuit substrate (not illustrated). With the contact portions 13, in order to come into contact with the electrodes of an electronic component to perform electric connection in a sure manner, the tip may be subjected to bending in a protruding shape, and may be formed on the tip portion of an arm-shaped portion 73 having elasticity. Also, in order to perform soldering as to a round of the circuit substrate, the connection portions 53 may be formed by being subjected to bending in an L-letter shape.

Also, the terminals 3 may be employed by a portion of the terminal base 93 being covered with the insulating resin PL. As illustrated in FIGS. 16A, 16B, and 18, the terminals 3 covered with this insulating resin PL may be disposed in the through-holes 15 disposed in an array shape so that the portion covered with the insulating resin PL may be fitted into the through-holes 15 of the metal plate 5. Thus, insulation between a signal terminal S3 and the metal plate 5 can be taken in a sure manner.

Also, as illustrated in FIG. 18, at least one of the multiple terminals 3 thus disposed may be taken as the signal terminal S3, and multiple terminals adjacent to the signal terminal S3 may be disposed so as to become ground terminals G3. Further, the terminal units 7 may be configured so that the signal terminals S3 and ground terminals G3 may be alternately disposed, and may be mounted on the metal plate 5. Therefore, regarding all of the signal terminals S3, the ground terminals G3 can be disposed so as to surround the signal terminals S3.

Also, regarding the terminals 3 of the electronic component socket 101 according to the present disclosure, as illustrated in FIGS. 17B and 17C, some of the multiple terminals 3 may be covered and linked with the insulating resin PL so as not to be electrically connected, thereby forming the terminal units 7. Thus, as compared to a case where the terminals 3 covered with the insulating resin PL are fitted into the through-holes 15 of the metal plate 5 one at a time, assembly properties can be improved. Note that the terminals 3 illustrated in FIGS. 17B and 17C may be made up of eight terminals, but the number of the terminals 3 is not restricted to eight as long as the number of the terminals 3 is greater than one.

The terminal units 7 may be embedded in the insulating resins PL of the multiple terminals 3 by insert molding using a synthetic resin material such as LCP (liquid crystal polymer) or the like. Also, the terminal units 7 may be blocks 7B which are a combination of two terminals 3, and four blocks 7B may be linked at the linking member 77.

The metal plate 5 has multiple divided through-holes 56 partitioned and divided by the partitions 75 as illustrated in FIGS. 16A and 16B, and in the event of a terminal unit 7 being inserted in the through-hole 15, two terminals 3 may be disposed in the divided through-holes 56. Also, as illustrated in FIG. 18, of the two terminals 3 disposed in the divided through-holes 56, the block 7B of the terminal unit 7 may be manufactured so that one of the terminals 3 becomes the signal terminal S3, and the other terminal 3 becomes the ground terminal G3.

With the terminal unit 7, as illustrated in FIGS. 17B and 17C, a groove 37 for housing a partition 75 of the metal plate 5 may be formed between the four blocks. Also, with the terminal unit 7, as illustrated in FIG. 17C, an opening groove 57 may be provided so as to come into contact with a protruding portion 35 of the metal plate 5, and a portion of the terminal base 93 of a terminal 3 is exposed.

Upon a terminal unit 7 having eight terminals 3 illustrated in FIGS. 17B and 17C being mounted on the metal plate 5 from the upward side (Z1 side), the two terminals 3 illustrated in FIG. 18 may be housed in one divide through-hole 56, the portion of the insulating resin PL may be fitted into four divided through-holes 56 sandwiching three partitions 75, and the eight terminals 3 may be disposed passing through the bottom wall 31 of the housing 1. Also, the insulating resin PL of the terminal unit 7 may be strongly fitted into a protruding portion 15t, the upper surface (Z1 side) of the partition 75 comes into contact with the lower face (Z2 side) of the linking member 77 as illustrated in FIGS. 18 and 19, and positioning is performed.

As described above, at the time of the terminal unit 7 being mounted, the protruding portion 35 of the metal plate 5 may come into contact with the ground terminal G3, and the ground terminal G3 and the metal plate 5 may be electrically conducted. Therefore, the metal plate 5 can be grounded, and accordingly, electric reflection noise or radiated noise can be shielded by the metal plate 5. Thus, shielding performance as to the signal terminals S3 can be improved. Note that the method for bringing the protruding portions 35 extended and provided from the inner walls 15i of the through-holes 15 of the metal plate 5 into contact with the ground terminal G3 has suitably been employed, but the electroconducting means are not restricted to this as long as the ground terminal G3 and the metal plate 5 are electrically conducted.

Also, the metal plate 5 which forms most of the bottom wall 31 of the housing 1 may be grounded, and accordingly, in the event that an electronic component has been housed in the housing portion 51 of the housing 1, and the electronic component socket 101 has been mounted on the circuit substrate, the ground layer of the metal plate 5 may be disposed between the electronic component and the circuit substrate. Thus, electric reflection noise or radiated noise can be shielded by the metal plate 5, and shielding performance as to the electronic component can be improved. Further, the bent portions 65 formed by bending a portion of the metal plate 5 may be disposed within the side wall 11 of the housing 1, and accordingly, the ground layer of the metal plate 5 may be disposed so as to surround up to the side face of the electronic component, and accordingly, shielding performance as to the electronic component can be improved.

Also, as illustrated in FIG. 18, the signal terminals S3 and ground terminals G3 may be alternately disposed, and accordingly, the ground terminals G3 can be disposed as to all of the signal terminals S3 so as to surround the signal terminals S3. Thus, electric reflection noise or radiated noise can be shielded by the ground terminals G3, and shielding performance as to all of the signal terminals S3 can further be improved. Also, even in the event that the signal terminals S3 and ground terminals G3 are not alternately disposed, if the ground terminals G3 are disposed so as to surround the signal terminals S3, shielding performance as to the signal terminals S3 can similarly be improved.

Also, as illustrated in FIGS. 18 and 19, the portion of the insulating resin PL covering the terminals 3 may be disposed by being fitted into the through-holes 15 of the metal plate 5, and accordingly, insulation between the signal terminals S3 and the metal plate 5 can be taken in a sure manner. Thus, shielding performance as to the signal terminals S3 can further be improved.

As described above, with the electronic component socket 101 according to the present embodiment of the present disclosure, the circumference of the signal terminals S3 may be surrounded with the ground terminals G3, and also the ground terminals G3 electrically conduct with the metal plate 5 via the electroconducting means, and accordingly, the metal plate 5 can be grounded. Thus, electric reflection noise or radiated noise can be shielded by the ground terminals G3 and metal plate 5, and shielding performance as to the signal terminals S3 can be improved.

Also, the protruding portions 35 extended and provided from the inner walls 15i of the through-holes 15 of the metal plate 5 may come into contact with the ground terminals G3, thereby electrically conducting between the ground terminals G3 and the metal plate 5, and accordingly, the ground terminals G3 and metal plate 5 can electrically conduct by the protruding portions 35 in a sure manner just by the ground terminals G3 being disposed within the through-holes 15 of the meal plate 5. Thus, the metal plate 5 can be grounded in a sure manner, and electric reflection noise or radiated noise can be shielded by the ground terminals G3 and metal plate 5, and accordingly, shielding performance as to the signal terminals S3 can be improved.

Also, the metal plate 5 may be made up of multiple metal materials, and the protruding portions 35 of at least one metal material of the metal materials, thereby electrically conducting between the ground terminals G3 and the metal plate 5, and accordingly, the ground terminals G3 and metal plate 5 can electrically conduct by the protruding portions 35 in a sure manner just by the ground terminals G3 being disposed within the through-holes 15 of the meal plate 5. Thus, the metal plate 5 can be grounded in a sure manner, and electric reflection noise or radiated noise can be shielded by the ground terminals G3 and metal plate 5, and accordingly, shielding performance as to the signal terminals S3 can be improved.

Also, the signal terminals S3 and ground terminals G3 may be alternately disposed, and accordingly, the ground terminals G3 can be disposed as to all of the signal terminals S3 so as to surround the signal terminals S3. Thus, electric reflection noise or radiated noise can be shielded by the ground terminals G3, and shielding performance as to all of the signal terminals S3 can further be improved.

Also, the metal plate 5 which forms most of the bottom wall 31 of the housing 1 may be grounded, and accordingly, an electronic component may be housed in the housing portion 51 of the housing 1, and at the time of the electronic component socket 101 being mounted on the circuit substrate, the ground layer of the metal plate 5 may be disposed between the electronic component and the circuit substrate. Thus, electric reflection noise or radiated noise can be shielded by the metal plate 5, and shielding performance as to the electronic component can be improved.

Also, the bent portions 65 formed by bending a portion of the metal plate 5 may be disposed within the side wall 11 of the housing 1, and accordingly, at the time of an electronic component being housed in the housing portion 51 of the housing 1, the ground layer of the metal plate 5 may be disposed so as to surround up to the side face of the electronic component, so electrical reflection noise or radiation noise can be shielded with the metal plate 5, and accordingly, shielding performance as to the electronic component can be improved.

Also, the portion of the insulating resin PL covering the terminals 3 may be disposed by being fitted into the through-holes 15 of the metal plate 5, and accordingly, insulation between the signal terminals S3 and the metal plate 5 can be taken in a sure manner. Thus, shielding performance as to the signal terminals S3 can further be improved.

The multiple terminals 3 may be covered and liked with the insulating resin PL, thereby forming a terminal unit 7, and accordingly, assembly properties can be improved as compared to a case where the terminals 3 are disposed in the through-holes 15 of the metal plate 5 one at a time.

Also, at least one of two terminals 3 disposed in the through-holes 15 is taken as the ground terminal G3, and accordingly, at least the two terminals 3 make up a pair including the ground terminal G3, and consequently, shielding performance as to the terminal 3 making up a pair with the ground terminal G3 can be improved.

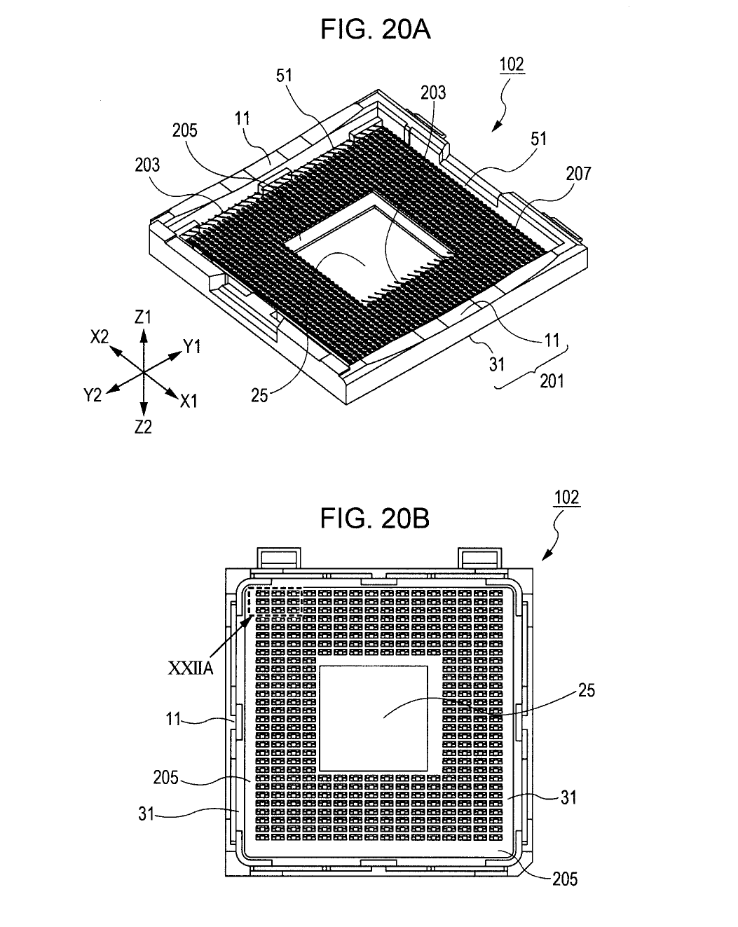

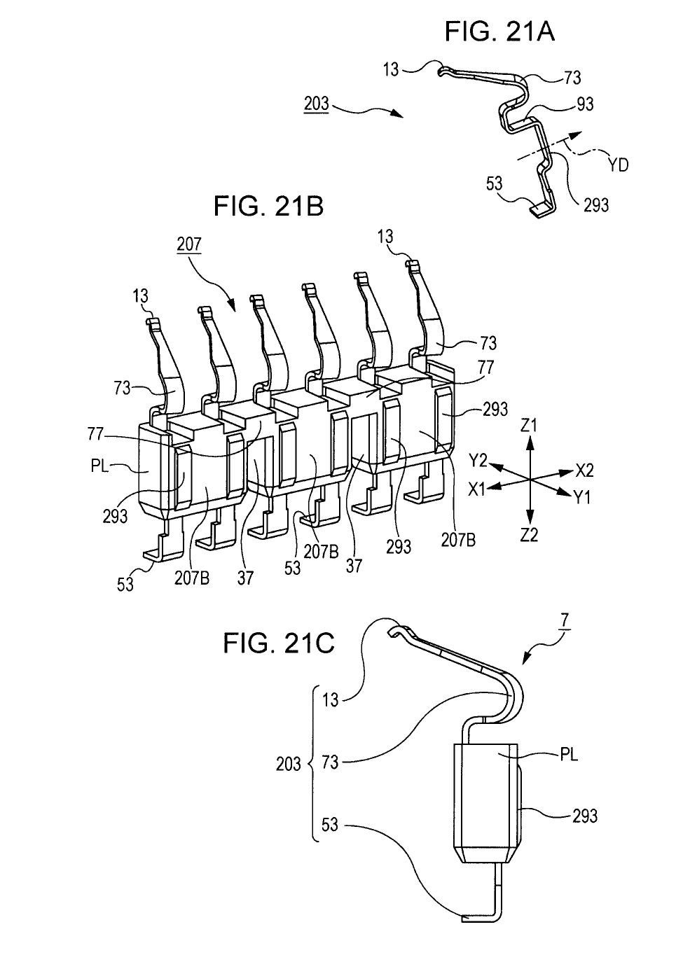

FIGS. 20A and 20B are diagrams for describing an electronic component socket 102 according to an exemplary embodiment of the present disclosure, wherein FIG. 20A is a perspective view, and FIG. 20B is a bottom view as viewed from the Z2 side illustrated in FIG. 20A. FIGS. 21A through 21C are diagrams for describing the electronic component socket 102 according to an exemplary embodiment of the present disclosure, wherein FIG. 21A is a perspective view of a terminal 203, FIG. 21B is a back perspective view of a terminal unit 207 as viewed from the Y1 side illustrated in

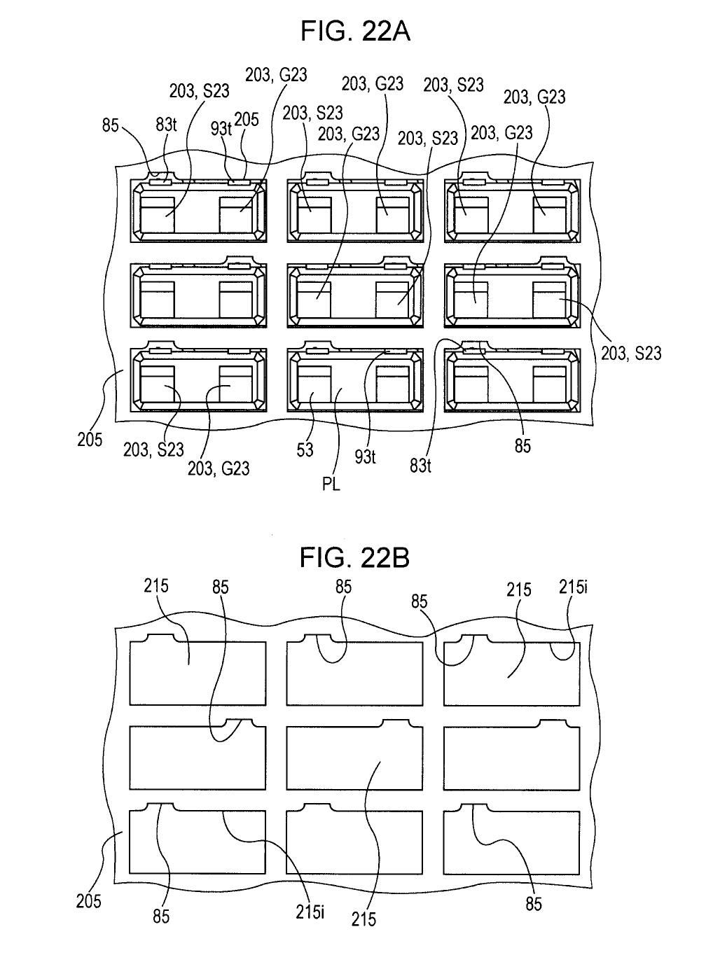

FIG. 20A, and FIG. 21C is a side view of the terminal unit 207 as viewed from the X1 side illustrated in FIG. 20A. FIGS. 22A and 22B are diagrams for describing the electronic component socket 102 according to an exemplary embodiment of the present disclosure, wherein FIG. 22A is an enlarged bottom view of the XXIIA portion illustrated in FIG. 20B, and FIG. 22B is an enlarged bottom view of a metal plate 205 from which the terminal unit 207 in FIG. 22A is omitted. The electronic component socket 102 according to this embodiment may differ from the above-described embodiment regarding the shape of the through-holes 215 of the metal plate 205, and the configuration of the terminal unit 203. Note that the same configurations as with the second embodiment are denoted with the same reference numerals, and detailed description thereof will be omitted.

The electronic component socket 102 according to this embodiment of the present disclosure may be configured of, as illustrated in FIGS. 20A and 20B, a housing 201 having the housing portion 51 surrounded with the side wall 11 and bottom wall 31, multiple terminals 203 to be disposed passing through the bottom wall 31 of the housing 201, and makes up a portion of the bottom wall 31 of the housing 201 with the metal plate 205.

The housing 201 may be formed in a square shape as illustrated in FIGS. 20A and 20B, and may form a recessed housing portion 51 surrounded with the side wall 11 and bottom wall 31 so as to house a rectangular electronic component (not illustrated) such as a BGA package or the like. A portion other than the metal plate 205 which forms the bottom wall 31, i.e., a portion of the side wall 11 and bottom wall 31 may be made up of a synthetic resin material such as, for example, LCP (liquid crystal polymer) or the like. The synthetic resin material may be employed, and accordingly, manufacturing can readily be performed by injection molding or the like. Note that, in the event of employing a thermosetting resin such as epoxy resin or the like, manufacturing can readily be performed by transfer molding.

The metal plate 205 may be formed in a square shape as illustrated in FIGS. 20A and 20B, or 22A and 22B, and may include multiple through-holes 215 for housing later-described multiple terminals 203, and the multiple through-holes 215 may be disposed in an array shape. Also, the metal plate 205 may be configured of one sheet of metal material. This metal plate 205 may be manufactured by subjecting a thin plate made up of iron alloy to appearance processing and hole processing using a metal mold.

Also, though not illustrated in the drawings, in the same way as with the above-described embodiment, the peripheral portion of the metal plate 205 may be embedded in the housing 201. A method for embedding this metal plate 205 in the housing 201 may be achieved by insert molding. Therefore, the housing 201 with a portion of the bottom wall 31 as metal can readily be formed. Thus, manufacturing can readily be performed, and manufacturing cost can be suppressed.

Also, as illustrated in FIGS. 22A and 22B, a recessed avoidance portion 85 for avoiding a later-described signal terminal protruding portion 83t may be provided to the inner walls 215i of the through-holes 215 of the metal plate 205 so as not to come into contact with a later-described signal terminal protruding portion 83t.

The terminals 203 may be manufactured in a pin shape by subjecting a thin plate made up of copper alloy to bending or punching using a metal mold, and are configured of, as illustrated in FIGS. 21A through 21C, a terminal base 93 of which a portion may be covered with the insulating resin PL, a contact portion 13 contactable with the electrodes (not illustrated) of an electronic component, and a connection portion 53 connectable with a round (not illustrated) of the circuit substrate.

Also, a protrusion 293 may extend in the YD direction illustrated in FIG. 21A from a portion of the terminal base 93 of a terminal 203. In the event of having employed this terminal 203 as a ground terminal G23, the protrusion 293 may become a ground terminal protruding portion 93t, and in the event of having employed this terminal 203 as a signal terminal S23, may become a signal terminal protruding portion 83t. Note that, the metal plate 205 may be brought into contact with the ground terminal protruding portion 93t (protrusion 293) using this ground terminal protruding portion 93t (protrusion 293) as electroconducting means, which will be described later.

Also, as illustrated in FIGS. 21B and 21C, some of the terminals 203 may be covered and liked with the insulating resin PL so that the terminals 203 are not electrically connected, thereby forming a terminal unit 207. Thus, as compared to a case where the terminals 203 covered with the insulating resin PL are disposed by being fitted into the through-holes 215 of the metal plate 205 one at a time, assembly properties can be improved. Note that, though the terminal unit 207 illustrated in FIGS. 21B and 21C may be configured of six terminals 203, the number of the terminals 203 is not restricted to six as long as the number of the six terminals is greater than one.

With the terminal units 207, the multiple terminals 203 may be embedded in the insulating resin PL by insert molding using a synthetic resin material such as LCP (liquid crystal polymer) or the like as the insulating resin PL. Also, the terminal units 207 may be blocks 207B made up of two terminals 203 being combined, and three blocks 207B may be linked with a liking member 77. Also, a groove 37 for housing a partition 75 of the metal plate 205 may be formed between the three blocks as illustrate in FIG. 21B and 21C. Also, the terminal units 207 may be configured to expose the plane portion from the insulating resin PL so that the plane portion extended in the YD direction of the protrusion 293 of a terminal 203 can come into contact with the metal plate 205. At this time, the mounting direction of the terminal 203 may be set so that the YD direction where the protrusion 293 is extended becomes a Y1 direction.

Upon the terminal unit 207 having six terminals 203 illustrated in FIGS. 21B and 21C being mounted on the metal plate 205 from the upward side (Z1 side), as illustrated in FIG. 22A, two terminals 203 may be housed in one through-hole 215, the portion of the insulating resin PL may be fitted into three through-holes 215 sandwiching two partitions 75, and consequently, the six terminals 203 may be disposed passing through the bottom wall 31 of the housing 201.

Also, as illustrated in FIG. 22A, of the two terminals 203 of a block 207B, one may be disposed as a single terminal S23, and the other may be disposed as a ground terminal G23, and further, the terminal unit 207 may be configured so that the signal terminals S23 and ground terminals G23 are alternately disposed, and may be mounted on the metal plate 205. The ground terminal protruding portions 93t (protrusions 293) may come into contact with the inner walls 215i of the through-holes 215 of the metal plate 205, the ground terminals G23 and metal plate 205 may be electrically conducted, and also the avoidance portions 85 are provided so that the signal terminal protruding portions 83t (protrusion 293) are not in contact with the metal plate 205, and accordingly, the signal terminals S23 and metal plate 205 may be insulated. The avoidance portions 85 may be provided, whereby the signal terminals S23 and metal plate 205 can be prevented from electrically conducting even in the event that the signal terminals S23 and ground terminals G23 exist. Thus, the signal terminals S23 and ground terminals G23 can be manufactured in common.

As described above, with the electronic component socket 102 according to the present embodiment of the present disclosure, at the time of a terminal unit 207 being mounted, the ground terminal protruding portions 93t extended and provided from the ground terminals G23 may come into contact with the inner walls 215i of the through-holes 215 of the metal plate 205, and the ground terminals G23 and metal plate 205 are electrically conducting in a sure manner. Therefore, the metal plate 205 can be grounded just by disposing the ground terminals G23 into the through-holes 215 of the metal plate 205, and accordingly, electric reflection noise or radiated noise can be shielded with the metal plate 205. Thus, shielding performance as to the signal terminals S23 can be improved.

Also, there may be provided the avoidance portions 85 for preventing the signal terminal protruding portion 83t provided to a signal terminal S23, and the metal plate 205 from being electrically conducted, and accordingly, even in the event that a signal terminal protruding portion 83t is provided to the signal terminal S23, the signal terminal S23 and metal plate 205 can be prevented from being electrically conducted. Thus, the signal terminals S23 and ground terminals G23 can be manufactured and employed in common, and manufacturing cost can be suppressed.

Also, the signal terminals S23 and ground terminals G23 are alternately disposed, and accordingly, the ground terminals G23 can be disposed as to all of the signal terminals S23 so as to surround the signal terminals S23. Thus, electric reflection noise or radiated noise can be shielded with the ground terminals G23, and shielding performance as to all of the signal terminals S23 can be improved.

Also, the metal plate 205 which forms most of the bottom wall 31 of the housing 201 is grounded, and accordingly, in the event that an electronic component has been housed in the housing portion 51 of the housing 201, and the electronic component socket 102 has been mounted on the circuit substrate, the ground layer of the metal plate 205 may be disposed between the electronic component and the circuit substrate. Thus, electric reflection noise or radiated noise can be shielded by the metal plate 205, and shielding performance as to the electronic component can be improved.

Also, the portion of the insulating resin PL covering the terminals 203 may be disposed by being fitted into the through-holes 215 of the metal plate 205, and accordingly, insulation between the signal terminals S23 and the metal plate 205 can be taken in a sure manner. Thus, shielding performance as to the signal terminals S23 can be improved.

Also, the multiple terminals 203 may be covered and liked with the insulating resin PL, thereby forming a terminal unit 207, and accordingly, assembly properties can be improved as compared to a case where the terminals 203 are disposed in the through-holes 215 of the metal plate 205 one at a time.

Note that the present disclosure is not restricted to the above embodiment, can be carried out by being modified such as the following, and these embodiments also belong to the technical scope of the present disclosure.

With the above-described embodiment, though the multiple terminals 3 are disposed passing through the bottom wall 31 of the housing 1 by the terminal units 7 being fitted into the through-holes 15 of the metal plate 5 suitably using the terminal units 7, an arrangement may be made wherein one terminal 3 is covered with the insulating resin PL, and the portion of the insulating resin PL is fitted into the through-holes 15 of the metal plate 5, and a single terminal 3 is sequentially disposed.

With the above-described embodiment, an arrangement has been made wherein the terminals 203 are disposed by the portion covered with the insulating resin PL being fitted into the through-holes 215 of the metal plate 205, but an arrangement may be made wherein the insulating resin PL is provided to a part or all of the inner wall 215i of the through-holes 215 of the metal plate 205, a terminal is pressed thereinto from back, and the terminal may be disposed passing through the bottom wall 31 of the housing 201. At this time, the terminal may have a shape whereby the terminal can readily be pressed thereinto, e.g., a shape with one side having a linear shape. Also, a recessed groove facing the Y2 direction illustrated in FIG. 21B may be provided to the flat plate portion of a ground terminal protruding portion 93t, and this recessed groove may be subjected to snap engagement so as to be fitted into a through-hole 215 of the metal plate 205 sandwiching the side wall of the through-hole 215 of the metal plate 205.

With the above-described embodiment, though the metal plate 205 is configured of a sheet of metal material having a flat plate shape, in the same way as with the second embodiment, an arrangement may be made wherein the metal plate 205 is configured of multiple metal materials, and moreover, a bent portion formed by a portion of the metal plate 205 being bent on the upward side (Z1 side) may be disposed within the side wall 11 of the housing 201. Therefore, at the time of an electronic component being housed in the housing portion 51 of the housing 201, the ground layer of the metal plate 205 is disposed so as to surround up to the side wall of the electronic component. Thus, electric reflection noise or radiated noise can be shielded by the metal plate 205, and shielding performance as to the electronic component can be improved.

The present disclosure is not restricted to the above embodiments, and can be modified as appropriate without departing from the spirit and scope of the present disclosure.

Accordingly, the embodiments of the present inventions are not to be limited in scope by the specific embodiments described herein. Further, although some of the embodiments of the present disclosure have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. An electronic component socket comprising:
a housing having a housing portion surrounded with a side wall and a bottom wall;
a plurality of terminals to be disposed so as to pass through said bottom wall of said housing; and
a metal plate configured to form at least a portion of said bottom wall of said housing, having a plurality of through-holes containable with said plurality of terminals;
wherein said plurality of terminals include
a contact portion contactable with an electrode of an electronic component containable with said housing, and
a connection portion connectable with a round of a substrate allocatable on the opposite side of said housing of said bottom wall;
and wherein said metal plate is embedded in said housing so that a portion thereof is exposed.

2. The electronic component socket according to claim 1, wherein a portion of said metal plate is bent and embedded in the side wall of said housing.

3. The electronic component socket according to claim 1, wherein an opening is provided to a central portion of said metal plate embedded in said bottom wall, and a protrusion extended toward said housing portion side is provided to the circumference of this opening.

4. The electronic component socket according to claim 1, wherein a slit is formed in a portion where said metal plate of said side wall is not disposed.

5. The electronic component socket according to claim 4, wherein said slit is formed on both sides of said side wall in one of a pair of said side walls facing.

6. The electronic component socket according to claim 1, wherein at least a part of said terminals are covered with an insulating resin;
and wherein said insulating resin portion is disposed so as to be fitted into the through-holes of said metal plate.

7. The electronic component socket according to claim 6, wherein a terminal unit is formed by covering and linking some of said plurality of terminals with an insulating resin so that each of the terminals is not electrically connected.

8. The electronic component socket according to claim 7, wherein the through-holes of said metal plate are provided so that said two or more terminals are housed;
and wherein said terminal unit is formed with a plurality of terminals so as to be housed in a plurality of said through-holes;
and wherein a groove portion is formed in said insulating resin portion for each of said two or more terminals;
and wherein a partitioning portion for partitioning said through-holes is provided to said groove portion at the time of implementation of said terminal unit as to said through-holes.

9. The electronic component socket according to claim 7, wherein a protruding or recessed portion for positioning said terminal unit is formed in the inner walls of the through-holes of said metal plate.

10. The electronic component socket according to claim 1, wherein said metal plate is made up of a plurality of metal materials, and at least one of said plurality of metal materials is bent and embedded within said side wall.

11. The electronic component socket according to claim 10, wherein at least one of said plurality of metal materials is embedded extended toward the upward side within said side wall, and another one is embedded extended toward the downward side within said side wall.

12. The electronic component socket according to claim 1, wherein said metal plate is made up of a plurality of metal materials, and said protrusion is formed as to at least one of said plurality of metal materials.

13. The electronic component socket according to claim 1, wherein said metal plate is made up of a plurality of metal materials, a metal material to be embedded within said side wall is disposed most downward, a metal material where said protrusion is formed is disposed most upward, and at least another metal material is disposed therebetween.

14. The electronic component socket according to claim 13, wherein a hole portion is provided to the central portion of a portion embedded in said bottom wall of said most downward metal material, and a downward protrusion extended toward said substrate side is formed in the circumference of said hole portion.

15. The electronic component socket according to claim 1, wherein a portion where said metal plate is embedded is embedded within said housing by insert molding.

16. The electronic component socket according to claim 1, wherein at least one of said plurality of terminals is taken as a signal terminal, said plurality of terminals adjacent to this signal terminal are taken as ground terminals, and said ground terminals electrically conduct with said metal plate via electroconducting means.

17. The electronic component socket according to claim 16, wherein said electroconducting means electrically conduct by protruding portions provided extended from the inner walls of said through-holes of said metal plate coming into contact with said ground terminals.

18. The electronic component socket according to claim 17, wherein said metal plate is made up of a plurality of metal materials, and said protruding portion is provided to at least one of said metal materials.

19. The electronic component socket according to claim 16, wherein said electroconducting means electrically conduct by ground terminal protruding portions provided extended from said ground terminals coming into contact with the inner walls of said through-holes of said metal plate.

20. The electronic component socket according to claim 19, wherein a signal terminal protruding portion extended from said signal terminal is provided to said signal terminal;
and wherein an avoidance portion configured so as not to electrically conduct with said signal terminal protruding portion is provided to said metal plate.

21. The electronic component socket according to claim 16, wherein, with said plurality of terminals, said signal terminals and said ground terminals are alternately disposed.

22. The electronic component socket according to claim 16, wherein at least a part of said terminals are covered with an insulating resin;
and wherein said insulating resin portion is disposed by being fitted into the through-holes of said metal plate.

23. The electronic component socket according to claim 22, wherein a terminal unit is formed by covering and linking some of said plurality of terminals with an insulating resin so that each of the terminals are not electrically connected.

24. The electronic component socket according to claim 23, wherein said through-holes are made up of a plurality of divided through-holes divided for at least every two terminals of a plurality of terminals provided to said terminal unit;
and wherein one of at least said two terminals provided to said divided through-holes is said ground terminal.
